(19) United States
(12) Patent Application Publication
(10) Pub. No.: US 2025/0111451 A1
(43) Pub. Date: Apr. 3, 2025

(54) ENERGY GENERATING SYSTEM FOR FACILITATING GENERATING ENERGY ON DEMAND

(71) Applicant: NewtonGen, Inc, Tampa, FL (US)

(72) Inventor: Richard Orlando Scarpelli, Tampa, FL (US)

(21) Appl. No.: 18/848,096

(22) PCT Filed: May 17, 2023
(86) PCT No.: PCT/US2023/022588

§ 371 Date: Sep. 17, 2024

Related U.S. Application Data
(60) Provisional application No. 63/321,007, filed on Mar. 17, 2022.

(51) Int. Cl. G06Q 50/06; G06Q 10/06

(52) U.S. Cl. CPC G06Q 50/06; G06Q 10/06

(57) ABSTRACT

An energy generating system for facilitating generating energy on demand. The energy generating system comprises a permanent magnet generator (PMG), a drive system, a power source, and an automatic voltage regulator (AVR). The drive system is mechanically coupled with the PMR using a gear assembly and drives the PMG generating electrical energy. The driving comprises driving the PMG during a starting phase and after the starting phase. The power source powers the drive system during the starting phase. The driving of the PMG during the starting phase is based on the powering of the drive system during the starting phase. The AVR electrically couples with the PMG and powers the drive system after the starting phase based on the electrical energy receivable by the AVR from the PMG. The driving of the PMG after the starting phase is based on the powering of the drive system after the starting phase.

### CROSS-REFERENCE TO RELATED APPLICATION

The current application claims a priority to the U.S. provisional patent application Ser. No. 63/321,007 filed on Mar. 17, 2022. The U.S. provisional patent application 63/321,007 is revived within the two-month period for unintentional abandonment by May 17, 2023.

### FIELD OF THE INVENTION

Generally, the present disclosure relates to the field of electromagnetic engines. More specifically, the present disclosure relates to an energy generating system for facilitating generating energy on demand.

### BACKGROUND OF THE INVENTION

The field of electromagnetic engines is technologically important to several industries, business organizations, and/or individuals. In particular, the use of electromagnetic engines is prevalent for operating a generator, a wind turbine, alternators, drivetrain, air compressors, air conditioners and fans, and/or any product that needs to spin with torque to operate.

Existing techniques for generating energy using electromagnetic engines are deficient with regard to several aspects. For instance, current technologies require fuel, nuclear energy, sun, wind, or water to generate energy. As a result, different technologies are needed that generate energy without requiring fuel, nuclear energy, sun, wind, or water.

Therefore, there is a need for an energy generating system for facilitating generating energy on demand that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an energy generating system for facilitating generating energy on demand, in accordance with some embodiments. Accordingly, the energy generating system may include at least one permanent magnet generator, at least one drive system, at least one power source, and at least one automatic voltage regulator. Further, the at least one drive system may be mechanically coupled with the at least one permanent magnet generator using a gear assembly. Further, the at least one drive system may be configured for driving the at least one permanent magnet generator. Further, the at least one permanent magnet generator may be configured for generating an electrical energy based on the driving. Further, the driving of the at least one permanent magnet generator may include driving the at least one permanent magnet generator during a starting phase and driving the at least one permanent magnet generator after the starting phase. Further, the at least one permanent magnet generator approaches an operating speed based on the driving of the at least one permanent magnet generator during the starting phase. Further, the at least one permanent magnet generator runs with the operating speed based on the driving of the at least one permanent magnet generator after the starting phase. Further, the at least one power source may be configured for powering the at least one drive system during the starting phase. Further, the driving of the at least one permanent magnet generator during the starting phase may be further based on the powering of the at least one drive system during the starting phase. Further, the at least one automatic voltage regulator may be electrically coupled with the at least one permanent magnet generator. Further, the at least one automatic voltage regulator may be configured for powering the at least one drive system after the starting phase based on the electrical energy receivable by the at least one automatic voltage regulator from the at least one permanent magnet generator. Further, the driving of the at least one permanent magnet generator after the starting phase may be based on the powering of the at least one drive system after the starting phase.

Further disclosed herein is an energy generating system for facilitating generating energy on demand, in accordance with some embodiments. Accordingly, the energy generating system may include at least one permanent magnet generator, at least one drive system, at least one power source, and at least one automatic voltage regulator. Further, the at least one drive system may be mechanically coupled with the at least one permanent magnet generator using a gear assembly. Further, the at least one drive system may be configured for driving the at least one permanent magnet generator. Further, the at least one permanent magnet generator may be configured for generating an electrical energy based on the driving. Further, the driving of the at least one permanent magnet generator may include driving the at least one permanent magnet generator during a starting phase and driving the at least one permanent magnet generator after the starting phase. Further, the at least one permanent magnet generator approaches an operating speed based on the driving of the at least one permanent magnet generator during the starting phase. Further, the at least one permanent magnet generator runs with the operating speed based on the driving of the at least one permanent magnet generator after the starting phase. Further, the at least one power source may be configured for powering the at least one drive system during the starting phase. Further, the driving of the at least one permanent magnet generator during the starting phase may be further based on the powering of the at least one drive system during the starting phase. Further, the at least one power source may be configured to be transitionable between a powering mode and an idle mode. Further, the at least one power source powers the at least one drive system during the starting phase in the powering mode. Further, the at least one power source does not power the at least one drive system after the starting phase. Further, the at least one automatic voltage regulator may be electrically coupled with the at least one permanent magnet generator. Further, the at least one automatic voltage regulator may be configured for powering the at least one drive system after the starting phase based on the electrical energy receivable by the at least one automatic voltage regulator from the at least one permanent magnet generator. Further, the driving of the at least one permanent magnet generator after the starting phase may be based on the powering of the at least one drive system after the starting phase.

Further disclosed herein is an energy generating system for facilitating generating energy on demand, in accordance with some embodiments. Accordingly, the energy generating system may include at least one permanent magnet generator, at least one drive system, at least one power source, and at least one automatic voltage regulator. Further, the at least one drive system may be mechanically coupled with the at least one permanent magnet generator using a gear assembly. Further, the at least one drive system may be configured for driving the at least one permanent magnet generator. Further, the at least one permanent magnet generator may be configured for generating an electrical energy based on the driving. Further, the driving of the at least one permanent magnet generator may include driving the at least one permanent magnet generator during a starting phase and driving the at least one permanent magnet generator after the starting phase. Further, the at least one permanent magnet generator approaches an operating speed based on the driving of the at least one permanent magnet generator during the starting phase. Further, the at least one permanent magnet generator runs with the operating speed based on the driving of the at least one permanent magnet generator after the starting phase. Further, the at least one drive system may include at least one motor. Further, the at least one power source may be configured for powering the at least one drive system during the starting phase. Further, the driving of the at least one permanent magnet generator during the starting phase may be further based on the powering of the at least one drive system during the starting phase. Further, the at least one power source may be configured to be transitionable between a powering mode and an idle mode. Further, the at least one power source powers the at least one drive system during the starting phase in the powering mode. Further, the at least one power source does not power the at least one drive system after the starting phase. Further, the at least one automatic voltage regulator may be electrically coupled with the at least one permanent magnet generator. Further, the at least one automatic voltage regulator may be configured for powering the at least one drive system after the starting phase based on the electrical energy receivable by the at least one automatic voltage regulator from the at least one permanent magnet generator. Further, the driving of the at least one permanent magnet generator after the starting phase may be based on the powering of the at least one drive system after the starting phase.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of an energy generating system 100 for facilitating generating energy on demand, in accordance with some embodiments.

FIG. 2 is a bottom view of the energy generating system 100, in accordance with some embodiments.

FIG. 3 is a right side view of the control assembly 108, in accordance with some embodiments.

FIG. 4 is a right side view of the control assembly 108, in accordance with some embodiments.

FIG. 5 is a left side perspective view of the piston receptacle 502, in accordance with some embodiments.

FIG. 6 is a front cross sectional view of a piston 600 of the two piston assemblies 104-106, in accordance with some embodiments.

FIG. 7 is a front view of the magnet shielding plate 402 of the at least one magnet shielding element 304, in accordance with some embodiments.

FIG. 8 is a front perspective view of a magnet shielding rod 306 of the at least one magnet shielding element 304, in accordance with some embodiments.

FIG. 9 is a front cross sectional view of the magnet shielding rod 306 of the at least one magnet shielding element 304, in accordance with some embodiments.

FIG. 10 is a top view of the energy generating system 100 with the at least one permanent magnet generator (1014 and 1016), in accordance with some embodiments.

FIG. 11 is a bottom perspective view of a permanent magnet generator 1014 of the energy generating system 100, in accordance with some embodiments.

FIG. 12 is a front view of the at least one automatic voltage regulator 1200 of the energy generating system 100, in accordance with some embodiments.

FIG. 13 is a bottom view of the gear assembly 1302 of the energy generating system 100 with the permanent magnet generator 1014, in accordance with some embodiments.

FIG. 14 is a top view of the gear assembly 1302 of the energy generating system 100 with the permanent magnet generator 1014, in accordance with some embodiments.

FIG. 15 is a rear view of the gear assembly 1302 of the energy generating system 100 with the permanent magnet generator 1014, in accordance with some embodiments.

FIG. 16 is a top view of a gear box 1602 with a gear linkage 1604 of the gear assembly 1302, in accordance with some embodiments.

FIG. 17 is a bottom view of a transmission 1702 of the gear assembly 1302 with the permanent magnet generator 1014, in accordance with some embodiments.

FIG. 18 is a rear perspective view of the energy generating system 100 with the at least one permanent magnet generator (1014 and 1016), in accordance with some embodiments.

FIG. 19 is a front perspective view of the energy generating system 100 with the at least one permanent magnet generator (1014 and 1016), in accordance with some embodiments.

FIG. 20 is a left side perspective view of the energy generating system 100 with the at least one permanent magnet generator (1014 and 1016), in accordance with some embodiments.

FIG. 21 is a top perspective view of a battery 2102 of the energy generating system 100, in accordance with some embodiments.

FIG. 22 is a top perspective view of an inverter 2204 of the energy generating system 100, in accordance with some embodiments.

FIG. 23 is a top perspective view of a controller 2302 of the energy generating system 100, in accordance with some embodiments.

FIG. 24 is a top perspective view of a digital automatic voltage regulator (AVR) 2402 of the energy generating system 100, in accordance with some embodiments.

FIG. 25 is a top perspective view of a circuit breaker 2502 of the energy generating system 100, in accordance with some embodiments.

FIG. 26 is a front perspective view of a human machine interface device 2600 associated with the energy generating system 100, in accordance with some embodiments.

FIG. 27 is a front view of an energy management system 2700 for the energy generating system 100, in accordance with some embodiments.

FIG. 28 is a perspective view of a stand 2802 for stacking a plurality of energy generating systems 2804-2808, in accordance with some embodiments.

FIG. 29 is a graph 2900 illustrating a plurality of outputs produced by an energy generating system against a speed of the energy generating system, in accordance with some embodiments.

FIG. 30 is a top view of an energy generating system 3000 for facilitating generating energy on demand, in accordance with some embodiments.

FIG. 31 is a top view of an energy generating system 3100 for facilitating generating energy on demand, in accordance with some embodiments.

FIG. 32 is an illustration of an online platform consistent with various embodiments of the present disclosure.

FIG. 33 is a block diagram of a computing device for implementing the methods disclosed herein, in accordance with some embodiments.

FIG. 34 is a disassembled front perspective view of an energy generating system 3400 for facilitating generating energy on demand, in accordance with some embodiments.

FIG. 35 is a disassembled top view of the energy generating system 3400, in accordance with some embodiments.

FIG. 36 is a front perspective view of the energy generating system 3400 with a housing 3602, in accordance with some embodiments

FIG. 37 is a front perspective view of the energy generating system 3400 with a housing 3702, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an energy generating system for facilitating generating energy on demand, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes an on-demand renewable energy generator (or on-demand magnet/electric motor-generator, or energy generating system). Further, the disclosed on-demand renewable energy generator may be used to spin and operate a generator, a wind turbine, alternators, a drivetrain, air compressors, air conditioners and fans, and/or any product that needs to spin with torque to operate. Further, the on-demand renewable energy generator may produce an output greater than the input necessary to run it. Further, the on-demand renewable energy generator may include various variants of 14 kW, 30 KW, 50 kW, etc. Further, the on-demand renewable energy generator may not require energy derived from sun, wind, water, or fossil fuels. Further, NewtonGen dual PMG (Permanent Magnet Generator), an exemplary embodiment of the disclosed on-demand renewable generator, may operate as redundancy or separate mode (independent operation) that may be 208Y/120V or 480/277V 3 phase configuration which is the USA's most common electrical system.

Further, the NewtonGen dual PMG may emerge as a revolutionary on-demand renewable dual electricity generation system that may be powered by a proprietary second-generation NewtonTRQ magnetic energy machine and may include an industrially hardened programmable logic controller (PLC), embedded with advanced machine learning algorithms that keep the highest efficiency. Further, NewtonTRQ magnetic energy machine may include a NewtonTRQ neodymium magnetic wheelhouse. Further, an optimal design of the NewtonTRQ neodymium magnetic wheelhouse may be a crucial part of designing. Further, a NewtonGen magnetic force may produce on-demand force >350 NM (Newton Meters) that may equal 258.15 LB-FT (Foot Pounds).

Further, the on-demand renewable energy generator (or NewtonGen on-demand renewable energy generator) may replace utilities, fuel generators, solar, and wind options at a fraction of the price.

Further, the on-demand renewable energy generator may include a control system and may use I/O, motors for operations. Further, the use of electric clutch transmission may result in a smooth, quiet operation. Further, the selection of materials used for a magnetic torque machine system may be a crucial part of designing.

Further, the on-demand renewable energy generator benefits over utilities, nuclear, solar, wind, and water. Further, the NewtonGen dual PMG may not require any AC coupled or battery bank on or off-grid which saves money and improves safety. Further, the on-demand renewable energy generator may operate on-demand 24/7 365 days regardless of the environment. Further, the on-demand renewable energy generator may not require fuels, nuclear, sun, wind, or water to operate and may produce electricity at an efficiency greater than 85%. Further, the on-demand renewable energy generator has the highest efficiency in renewable electricity and or public utilities on the earth today.

The system performance features of the on-demand magnet/electric motor-generator may include an automatic voltage regulator (OAVR) output that may be 208Y/120V or 480/277 V 3ph @ 3 kW through 25 kW, levels of noise in decibels 60 (dB) level, public utility commission approved bidirectional revenue meter, JuiceBox 40 WiFi-enabled 40-amp smart EV charging station (level 2 EVSE) with 25-foot cable& integrated cable management (up to 7× faster charging), industrially hardened programmable logic controller (PLC) with CANopen Communication Protocol, stackable enclosures, on or off Grid Controller, automatic transfer switches, servo electronic voltage stabilizers with the digital automatic voltage regulator (AVR), and 8/20-year warranty.

The NewtonGen on-demand Renewable energy generator may have a standard output of 2×7 KW, 2×15 KW, 2×25 kW. The Dual PMG (Permanent Magnet Generator) may operate as redundancy or Separate Mode (independent operation). Further, dimensions may be 22.0 inch or 558.8 mm (height)×33.0 inch or 838.2 mm (width)×28.0 inch or 711.2 mm (length) weight: 350 lbs, 159 kg to 570 lbs, 259 kg. Further, system operating temperature may be from 0° C. to 70° C. and levels of noise in decibels 60 (dB) level.

Further, the dual PMG (Permanent Magnet Generator) may operate as a redundancy or separate mode (independent operation) with rated power (W) 14 kW, 30 kW, or 50 kW. The performance features of the dual PMG may include 208Y/120V or 480/277 V three-phase configuration which is the USA's most common electrical system. Optional voltages may include 120 V/240 V, 110 V/220 V, 220 V, 230 V, 240 V, 120 V, and 110 (V60 Hz or 50 Hz). Further, a radial flux rare earth permanent magnet generator (PMG) may be synchronous, where the rotor windings have been replaced with permanent magnets for eliminating the excitation losses in a rotor, otherwise, typically 20 to 30 percent of the total generator losses may happen and leads to considerable higher part-load efficiency for the PMG compared to asynchronous generators. Further, the performance features may include a brushless structure, free maintenance, and electrical efficiency of 85%.

Further, the on-demand renewable energy generator may emerge as a useful asset for renewable energy generation in countries such as Haiti, Costa Rica, Mexico, Puerto Rico, Panama, Columbia, Bolivia, Brazil, Asia, Africa, Australia, India, Germany, and Canada.

Further, the performance features of NewtonGen servo electronic voltage stabilizers with the digital automatic voltage regulator (AVR) may include an LCD servo electronic-based voltage stabilizer with the digital automatic voltage regulator (AVR) that may handle the widest of input voltage windows excess of 40% and still capable of delivering accuracy on the output of 1% or superior, inbuilt unparalleled protection features with fast speed of response and, stabilizer/regulator, three-phase servo electronic-based voltage stabilizers deliver voltage stabilization with a digital automatic voltage regulator (AVR), protection from voltage surge and spike protection without compromising on technical performance or quality.

Further, the performance features of NewtonGen 7-inch Human Machine Interface (or HMI) and automatic power transfer switches may include, system and voltage monitoring & protection, automatic transfer switch selection between the normal/NewtonGen or spare/utilities to ensure the continuity, reliability, and safety of power supply, and a wall-mounted distribution box with the NewtonGen 7-inch human-machine interface and newly developed automatic transfer switch with early warning intelligent functions of residual current detector for electric fire prevention (early warning function) when the three-phase current, residual current, and wire/cable temperature of the controlled circuit reaches the preset pre-warning value. Further, it may send out pre-warning visual signal only to remind the operator to handle the trouble in time, to avoid unexpected tripping or failure.

Further, the present disclosure describes a NewtonGen on-demand renewable energy generating system (energy generating system). Further, the disclosed system is totally self-contained and produces clean sustainable energy/electricity using only a battery to starting and operate and stopping. The system starts using the battery and inverter once the system has started and is up to the running RPM/speed the AVR switches over to the permanent magnet generator and now supplying the drive system with the operating voltage to run system. Also, the battery and inverter are now in idle mode≤0.1A. Further, the system operation is at 10% energy cost. Meaning 60 KW PMG only has 54 kW output to system circuit breakers. 60,000 watts-60000 watts of 10%=54,000 watts. Further, the system may include a gearbox with a linkage. Further, the linkage only moves 45 deg to make 360 deg rotation. Further, the system may be wired in parallel to supply more AMP/current allowing building of gigawatts distribution systems. Further, the system may produce AC or DC voltage.

Further, the present disclosure describes an on-demand renewable energy generator (energy generating system). Further, the on-demand renewable energy generator may include at least one PMG (or permanent magnet generator), a plurality of electromagnetic clutches, a piston-cylinder housing, a BLDC control system motor, a machine housing, etc. Further, the on-demand renewable energy generator may be controlled by a plurality of proprietary algorithms (or software). Further, the on-demand renewable energy generator may be powered by an onboard battery. Further, the plurality of electromagnetic clutches may be disposed in the machine housing. Further, the at least one PMG may be partially disposed in the machine housing. Further, the at least one PMG may be mechanically coupled with at least one electromagnetic clutch of the plurality of electromagnetic clutches. Further, the at least one PMG may be configured for converting mechanical energy into electrical energy. Further, the piston-cylinder housing may be disposed in the machine housing. Further, the piston-cylinder housing may include at least one spring. Further, the piston-cylinder housing may include a plurality of magnets. Further, the piston-cylinder housing may include a magnetic shielding case. Further, the magnetic shielding case may include a magnetic shield. Further, the magnetic shield may include at least one of a magnetic shielding rod and a magnetic shielding plate. Further, the piston-cylinder housing may include at least one magnetic piston and a cylinder. Further, the at least one magnetic piston may slide inside the cylinder. Further, the at least one magnetic piston may be mechanically coupled with at least one drive shaft through at least one linkage. Further, the at least one magnetic piston may generate an output torque on the at least one drive shaft. Further, the at least one drive shaft may rotate with X RPMs. Further, the on-demand renewable energy generator may include a control system that may include the plurality of proprietary algorithms. Further, the BLDC control system motor may be disposed in the machine housing. Further, the plurality of electromagnetic clutches may be controlled by the plurality of proprietary algorithms, transmitting torque mechanically resulting in a smooth, quiet operation. Further, the BLDC control system motor and the plurality of proprietary algorithms may set the speed of the on-demand renewable energy generator and the at least one magnetic piston. Further, the on-demand renewable energy generator may be designed to operate any off-the-shelf PMG (Permanent Magnet Generator).

Further, the on-demand renewable energy generator may include a base system. Further, the base system comprises a plurality of electromagnetic clutch, a piston-cylinder housing, a BLDC control system motor, a machine housing, etc. Further, the piston-cylinder housing may be disposed in the machine housing. Further, the piston-cylinder housing may be self-lubricating with an extremely low coefficient of friction. Further, the piston-cylinder housing may include at least one magnetic piston and a cylinder. Further, the at least one magnetic piston may be self-lubricating with an extremely low coefficient of friction. Further, the at least one magnetic piston may slide inside the cylinder. Further, the piston-cylinder housing may include a magnetic shielding case. Further, the at least one magnetic piston may include at least one magnet. Further, the piston-cylinder housing may include at least one spring. Further, the BLDC control system motor may spin a magnetic shielding rod and/or a magnetic shielding plate. Further, the spinning of the magnetic shielding rod and/or the magnetic shielding plate may interrupt the magnetic field and allow the at least one magnetic piston to compress and retract the at least one spring. Further, compressing of the at least one spring by the at least one magnetic piston may cycle more than fifty compressions every second. Further, the diameter of the magnetic shielding rod, size of at least one magnet of the plurality of magnets, and speed of the BLDC control system motor may be in direct correlation to the speed of the at least one magnetic piston. Further, in some embodiments, the size of the magnetic shielding case may be three millimeters. Further, the magnetic shielding rod may be made of N52, NI+EPOXY magnetic material, etc. Further, the magnetic shielding case may include a 3 mm shield case. Further, the magnetic shielding plate may include a 5 mm silicon iron plate. Further, the magnetic shielding rod may include a 10 mm soft magnetic rod. Further, in some embodiments, the piston-cylinder housing and the at least one magnetic piston may be made of polyetheretherketone (PEEK PVE ultimate self-lubricating) with additives that enhance wear resistance. Further, the piston-cylinder housing and the at least one magnetic piston may be highly wear-resistant with an extremely low coefficient of friction that increases speed and reduces wear vibration damping. Further, the piston-cylinder housing and the at least one magnetic piston may be temperature resistant from −212° F. to +482° F. in continuous operation. Further, in some embodiments, the at least one magnetic piston may include two magnetic pistons. Further, a reciprocating motion of the two magnetic pistons may be controllable by the control system. Further, the reciprocating motion of the two magnetic pistons may be converted to two rotary motions. Further, the two rotary motions may be utilized to produce torque and RPMs. Further, the thickness of the magnetic shielding case may vary based on the size and strength (surface Gauss value) of at least one magnet of the plurality of magnets. Further, the at least one magnet of the plurality of magnets may include a north pole and a south pole. Further, the at least one drive shaft may include two drive shafts. Further, the at least one linkage may include two linkages. Further, the plurality of magnets may include two magnets. Further, the at least one spring may include two springs. Further, the two magnets may be disposed in a housing and pressed towards each other by the two springs. Further, compression of the two springs may pass the magnetic shield over the two magnets and the two springs may fully extend the two magnetic pistons. Further, the reciprocating motion of the two magnetic pistons may be controlled by the BLDC control system motor. Further, the two magnets may experience a strong repulsion from each other if the north poles of the two magnets come close together. Further, the strong repulsion may compress the two springs and through the two linkages, may turn the two drive shafts to generate output torque and RPMs. Further, the diameter of the magnetic shield, size of the two magnets, and speed of the BLDC control system motor may be in direct correlation to the speed of the two magnetic pistons. Further, the magnetic shield may shield the at least one magnet around the sides and back of the at least one magnet and only expose at least one of the north pole and the south pole. Further, eliminating the magnetic properties from around the at least one magnet focuses, adds more force, and eliminates the stopping, push, pull of the at least one magnet until passing over another magnet of the plurality of magnets. Further, starting and running, and stopping the magnetic field and placement and pitch of the plurality of magnets may be a crucial part of operating the on-demand renewable energy generator. Further, the magnetic field may be controlled with advanced learning algorithms. Further, the output torque and the RPMs may be controlled by the manipulation of the magnetic field. Further, in an embodiment, three on-demand renewable energy generators may be stacked together. Further, a height of the three on-demand renewable energy generators stacked together may be 3-8 feet and provides 150 KW of energy. Further, a dimension of the three on-demand renewable energy generators stacked together may be 70 inches (height), 40 inches (width), and 28 inches (length).

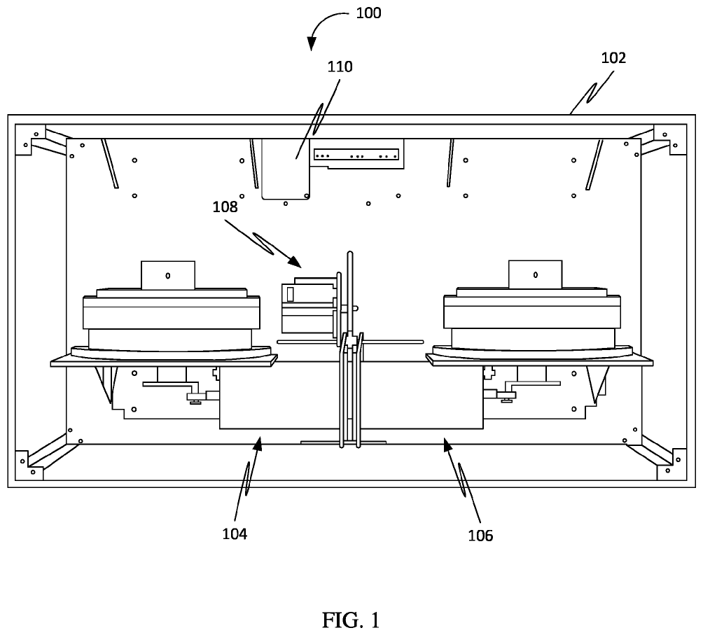

FIG. 1 is a top view of an energy generating system 100 for facilitating generating energy on demand, in accordance with some embodiments. Accordingly, the energy generating system 100 may include a housing 102, two piston assemblies 104-106, and a control assembly 108.

Further, the two piston assemblies 104-106 may be disposed in the housing 102. Further, the two piston assemblies 104-106 may include piston-cylinder housing Further, the two piston assemblies 104-106 may include a first piston assembly 104 and a second piston assembly 106. Further, the first piston assembly 104 opposes the second piston assembly 106. Further, the first piston assembly 104 may be spaced apart from the second piston assembly 106 defining a space 238 between the first piston assembly 104 and the second piston assembly 106. Further, each of the two piston assemblies 104-106 may include a cylinder (202 and 204), a piston (206 and 208) (such as a magnetic piston) movably disposed in the cylinder (202 and 204), and a connecting rod (210 and 212) coupled with the piston (206 and 208). Further, the cylinder (202 and 204) may include a spring (214 and 216) coupled with the piston (206 and 208). Further, a first end (218 and 220) of the spring (214 and 216) may be attached to a first end portion (222 and 224) of the cylinder (202 and 204) and a second end (226 and 228) of the spring (214 and 216) may be attached to a rear surface (230 and 232) of the piston (206 and 208). Further, the piston (206 and 208) may include a magnet (240 and 242). Further, the magnet 240 of the piston 206 of the first piston assembly 104 magnetically interacts with the magnet 242 of the piston 208 of the second piston assembly 106 imparting a magnetic repulsion force on the piston 206 of the first piston assembly 104 and the piston 208 of the second piston assembly 106 for moving the piston (206 and 208) within the cylinder (202 and 204) in a first direction. Further, the spring (214 and 216) transitions from an extended state to a compressed state based on the moving of the piston (206 and 208) within the cylinder (202 and 204) in the first direction. Further, the spring (214 and 216) may be configured for transitioning from the compressed state to the extended state for moving the piston (206 and 208) within the cylinder (202 and 204) in a second direction opposite to the first direction. Further, the magnetically repelling of the piston (206 and 208) and the transitioning of the spring (214 and 216) from the compressed state to the extended state establishes a reciprocating movement of the piston (206 and 208) in the cylinder (202 and 204). Further, the connecting rod (210 and 212) may be coupled with a shaft (such as a drive shaft) (234 and 236) disposed in the housing 102. Further, the reciprocating movement of the piston (206 and 208) rotates the shaft (234 and 236) with at least one speed and at least one torque. Further, the shaft (234 and 236) outputs a rotational energy based on the at least one speed and the at least one torque.

Further, the control assembly (such as a control system) 108 may be disposed in the housing 102. Further, the control assembly 108 may include at least one magnet shielding element 304 (such as a magnetic shielding plate, a magnetic shielding rod, etc.) and an actuator 302 (such as a BLDC motor) operatively coupled with the at least one magnet shielding element 304. Further, the actuator 302 may be electrically powered. Further, the actuator 302 may be configured for transitioning the at least one magnet shielding element 304 between a first position and at least one second position in relation to the space 238. Further, the transitioning of the at least one magnet shielding element 304 may include rotating the at least one magnet shielding element 304 between the first position and the at least one second position in relation to the space 238. Further, the transitioning of the at least one magnet shielding element 304 modifies a magnetic interaction between the magnet 240 of the piston 206 of the first piston assembly 104 and the magnet 242 of the piston 208 of the second piston assembly 106 varying the magnetic repulsion force between a first amount and at least one second amount. Further, the moving of the piston (206 and 208) within the cylinder (202 and 204) in the first direction may be based on the first amount of the magnetic repulsion force. Further, the transitioning of the spring (214 and 216) from the compressed state to the extended state for the moving of the piston (206 and 208) within the cylinder (202 and 204) in the second direction may be based on the at least one second amount of the magnetic repulsion force.

Further, in some embodiments, the at least one magnet shielding element 304 allows the magnetic interaction in the first position for varying the magnetic repulsion force to the first amount. Further, the at least one magnet shielding element 304 interrupts the magnetic interaction of at least one amount in the at least one second position for varying the magnetic repulsion force to the at least one second amount.

Further, in some embodiments, the transitioning of the at least one magnet shielding element 304 between the first position and the at least one second position in relation to the space 238 may include transitioning the at least one magnet shielding element 304 between the first position and the at least one second position in relation to the space 238 with at least one transitioning characteristic. Further, the at least one transitioning characteristic may include a speed of rotation, a cycle of rotation, a path of rotation, etc., of the at least one magnet shielding element 304. Further, the at least one characteristic corresponds to at least one reciprocating movement characteristic of the reciprocating movement of the piston (206 and 208). Further, the at least one speed and the at least one torque associated with the shaft (234 and 236) corresponds to the at least one reciprocating movement characteristic. Further, the at least one reciprocating movement characteristic may include a speed of the piston (206 and 208) in the reciprocating movement, a cycle of the piston (206 and 208) in the reciprocating movement, etc.

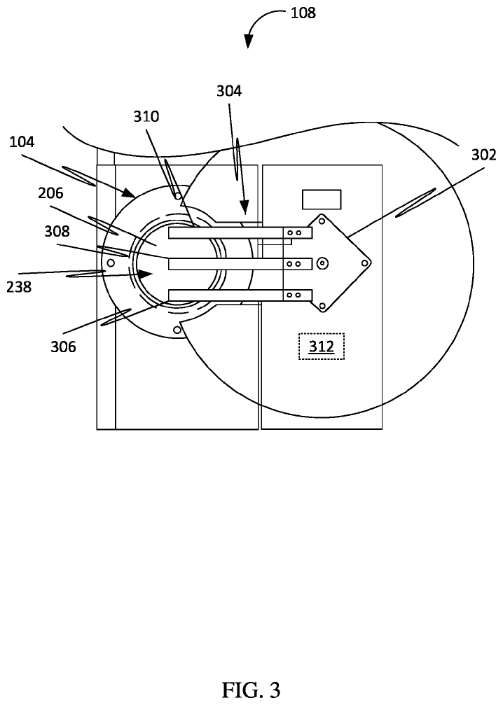

Further, in an embodiment, the control assembly 108 further may include a processor 312, as shown in FIG. 3, communicatively coupled with the actuator 302. Further, the processor 312 may be a processing device of a computing device. Further, the processor 312 may be configured for determining the at least one transitioning characteristic for the transitioning of the at least one magnet shielding element 304 between the first position and the at least one second position in relation to the space 238. Further, the processor 312 may be configured for generating a command for the actuator 302 based on the determining. Further, the transitioning of the at least one magnet shielding element 304 between the first position and the at least one second position in relation to the space 238 with the at least one transitioning characteristic may be based on the command. Further, in an embodiment, the control system 108 may include a communication interface communicatively coupled with the processor 312. Further, the communication interface may be configured for receiving an input from at least one user device (such as a computing device). Further, the determining of the at least one transitioning characteristic may be based on the input.

Further, in an embodiment, the determining of the at least one transitioning characteristic for the transitioning of the at least one magnet shielding element 304 between the first position and the at least one second position in relation to the space 238 may include determining the at least one transitioning characteristic for the transitioning of the at least one magnet shielding element 304 between the first position and the at least one second position in relation to the space 238 based on at least one machine learning model. Further, the at least one machine learning model predicts values for transitioning characteristics associated with the transitioning of the at least one magnet shielding element 304. Further, in an embodiment, the control system 108 may include a storage device communicatively coupled with the processor 312. Further, the storage may be configured for storing the at least one machine learning model. Further, in an embodiment, the control system 108 may include a communication interface communicatively coupled with the processor 312. Further, the communication interface may be configured for receiving the at least one machine learning model from at least one user device (such as a computing device).

Further, in some embodiments, the piston (206 and 208) may include a piston receptacle 502 may include a piston interior space 504, and a piston opening 506 leading into the piston interior space 504. Further, the magnet (240 and 242) may be disposed in the piston interior space 504. Further, a first pole of a first polarity of the magnet (240 and 242) faces a first end side 508 of the piston receptacle 502 and a second pole of a second polarity of the magnet (240 and 242) faces a second end side 510 of the piston receptacle 502. Further, the first end side 508 opposes the second end side 510. Further, the piston opening 506 may be comprised on the first end side 508.

Further, in an embodiment, the piston receptacle 502 shields at least a portion of a magnetic field associated with the magnet (240 and 242) for defining a field profile for the magnetic field associated with the magnet (240 and 242). Further, the magnetic interaction may be based on an interaction of the magnetic field with the field profile of the magnet 240 of the first piston assembly 104 and the magnetic field with the field profile of the magnet 242 of the second piston assembly 106.

Further, in some embodiments, the at least one magnet shielding element 304 may be comprised of at least one material. Further, the at least one material may include silicon iron alloy.

In further embodiments, the energy generating system 100 may include at least one power source 110 disposed in the housing 102. Further, the at least one power source 110 may be electrically coupled with the actuator 302 of the control assembly 108. Further, the at least one power source 110 may be configured for electrically powering the actuator 302.

In further embodiments, the energy generating system 100 may include at least one electromagnetic clutch (1002 and 1004) coupled with at least one of the two piston assemblies 104-106. Further, the at least one electromagnetic clutch (1002 and 1004) may be electrically powered. Further, the at least one electromagnetic clutch (1002 and 1004) may include an input member (1006 and 1008) and an output member (1010 and 1012). Further, the input member (1006 and 1008) may be mechanically coupled with the shaft (234 and 236) for receiving the rotational energy from the shaft (234 and 236). Further, the at least one electromagnetic clutch (1002 and 1004) may be configured for transmitting the rotational energy received at the input member (1006 and 1008) to the output member (1010 and 1012) based on at least one operation of the at least one electromagnetic clutch (1002 and 1004). Further, the at least one operation may include engaging the input member (1006 and 1008) with the output member (1010 and 1012). Further, the at least one operation may include disengaging the input member (1006 and 1008) from the output member (1010 and 1012).

In an embodiment, the energy generating system 100 may include at least one permanent magnet generator (PMG) (1014 and 1016) disposed on the housing 102. Further, the at least one permanent magnet generator (1014 and 1016) may be coupled with the at least one electromagnetic clutch (1002 and 1004). Further, a rotor shaft (1018 and 1020) of the at least one permanent magnet generator (1014 and 1016) may be mechanically coupled with the output member (1010 and 1012) of the at least one electromagnetic clutch (1002 and 1004). Further, the at least one permanent magnet generator (1014 and 1016) converts the rotational energy received at the rotor shaft (1018 and 1020) to an electrical energy.

In an embodiment, the energy generating system 100 may include a gear assembly 1302 disposed in the housing 102. Further, the gear assembly 1302 may be coupled with at least one electromagnetic clutch (1002 and 1004) and the at least one permanent magnet generator (1014 and 1016). Further, the output member (1010 and 1012) mechanically couples with the rotor shaft (1018 and 1020) using the gear assembly 1302.

In an embodiment, the energy generating system 100 may include at least one automatic voltage regulator 1200 electrically coupled with the at least one permanent magnet generator (1014 and 1016). Further, the at least one automatic voltage regulator 1200 may be configured for electrically powering the actuator 302 of the control assembly 108 based on receiving the electrical energy.

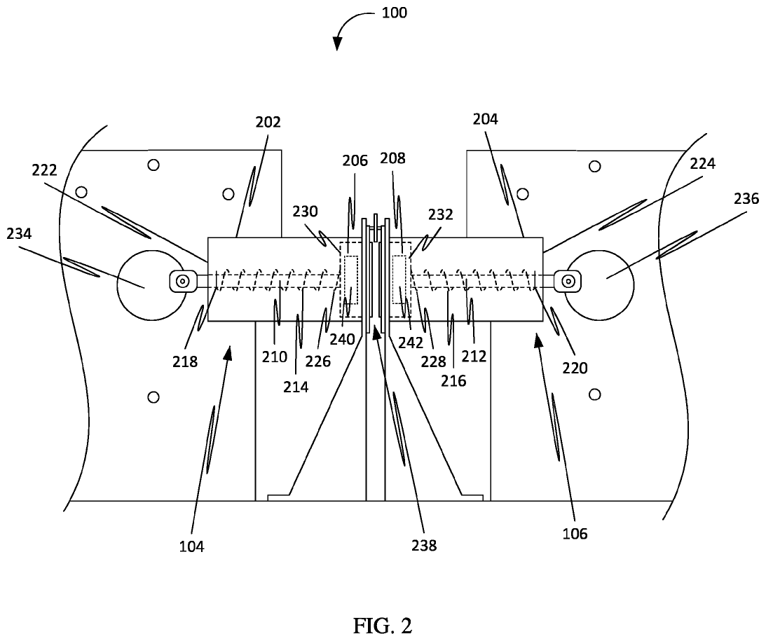

FIG. 2 is a bottom view of the energy generating system 100, in accordance with some embodiments.

FIG. 3 is a right side view of the control assembly 108, in accordance with some embodiments. Further, the at least one magnet shielding element 304 of the control assembly 108 may include a plurality of magnet shielding rods 306-310. Further, the plurality of magnet shielding rods 306-310 may be spacedly coupled to the actuator 302. Further, the plurality of magnet shielding rods 306-310 may be associated with a diameter.

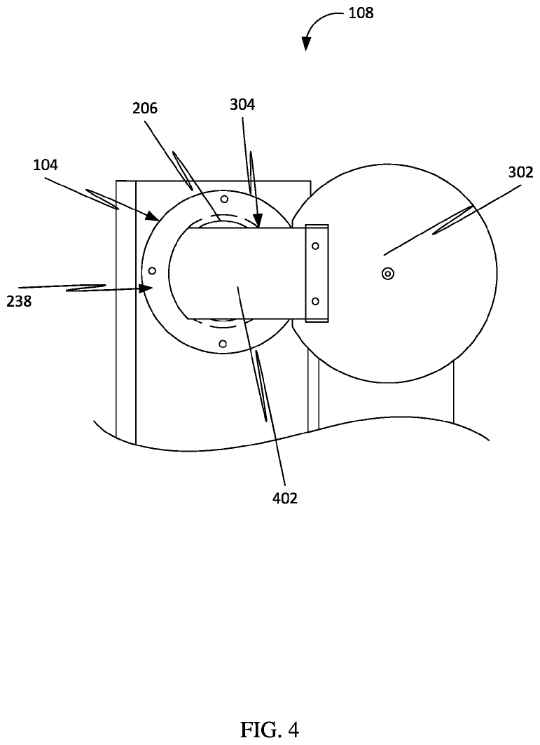

FIG. 4 is a right side view of the control assembly 108, in accordance with some embodiments. Further, the at least one magnet shielding element 304 of the control assembly 108 may include a magnet shielding plate 402. Further, the magnet shielding plate 402 may be coupled to the actuator 302.

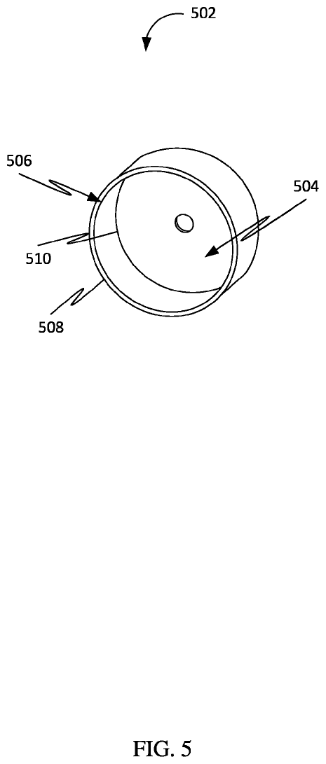

FIG. 5 is a left side perspective view of the piston receptacle 502, in accordance with some embodiments.

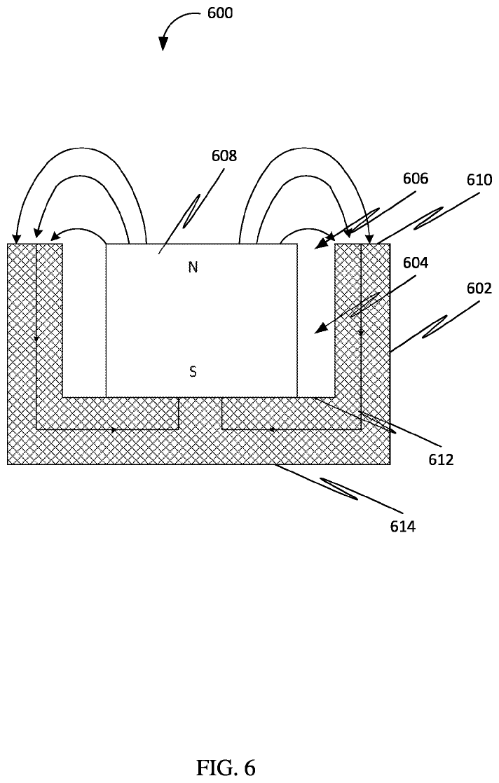

FIG. 6 is a front cross sectional view of a piston 600 of the two piston assemblies 104-106, in accordance with some embodiments. Further, the piston 600 may include a piston receptacle 602 may include a piston interior space 604, and a piston opening 606 leading into the piston interior space 604. Further, a magnet 608 may be disposed in the piston interior space 604. Further, a first pole of a first polarity of the magnet 608 faces a first end side 610 of the piston receptacle 602 and a second pole of a second polarity of the magnet 608 faces a second end side 612 of the piston receptacle 602. Further, the first end side 610 opposes the second end side 612. Further, the piston opening 606 may be comprised on the first end side 610.

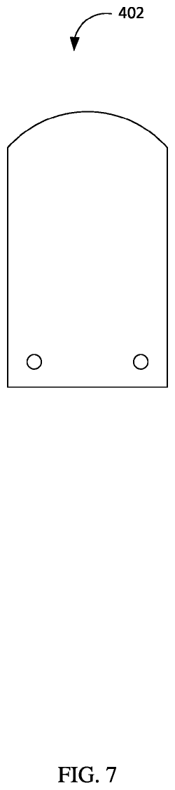

FIG. 7 is a front view of the magnet shielding plate 402 of the at least one magnet shielding element 304, in accordance with some embodiments.

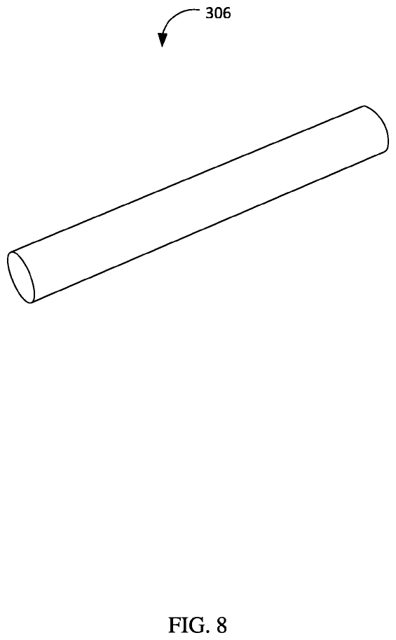

FIG. 8 is a front perspective view of a magnet shielding rod 306 of the at least one magnet shielding element 304, in accordance with some embodiments.

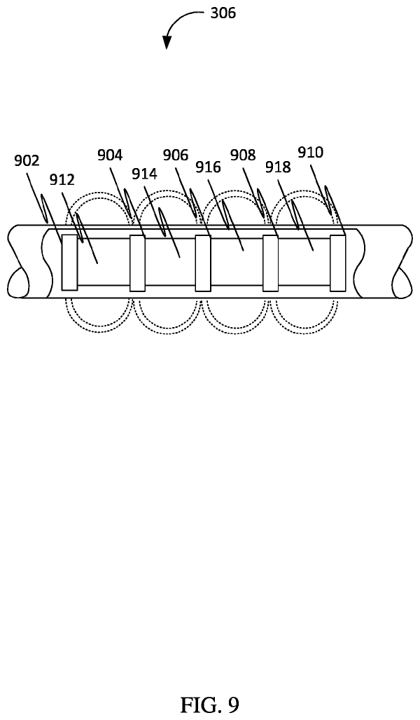

FIG. 9 is a front cross sectional view of the magnet shielding rod 306 of the at least one magnet shielding element 304, in accordance with some embodiments. Further, the magnet shielding rod 306 may include a plurality of pole pieces 902-910 spacedly disposed within the magnet shielding rod 306 defining a space between each two of the plurality of pole pieces 902-910. Further, the magnet shielding rod 306 may include a plurality of magnets 912-918 disposed within the magnet shielding rod 306. Further, each of the plurality of magnets 912 may be disposed in the space between each two of the plurality of pole pieces 902-910.

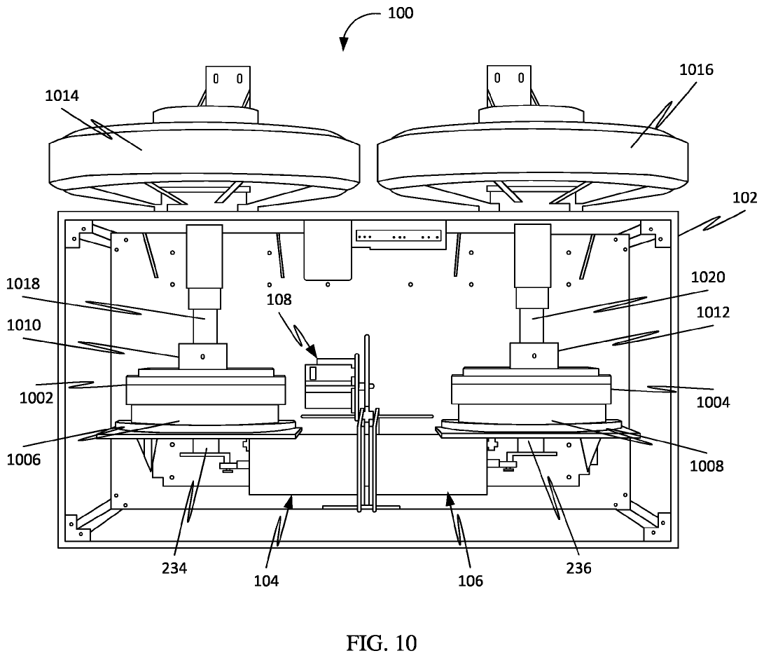

FIG. 10 is a top view of the energy generating system 100 with the at least one permanent magnet generator (1014 and 1016), in accordance with some embodiments.

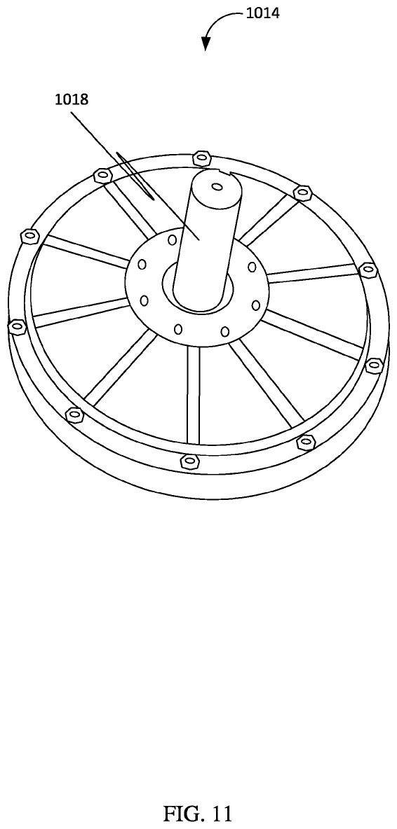

FIG. 11 is a bottom perspective view of a permanent magnet generator 1014 of the energy generating system 100, in accordance with some embodiments.

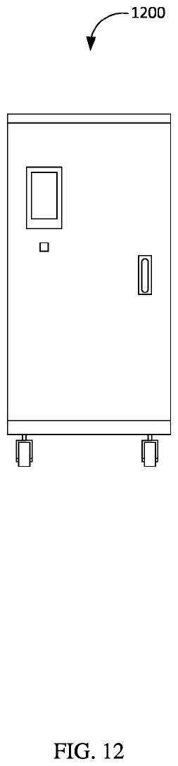

FIG. 12 is a front view of the at least one automatic voltage regulator 1200 of the energy generating system 100, in accordance with some embodiments.

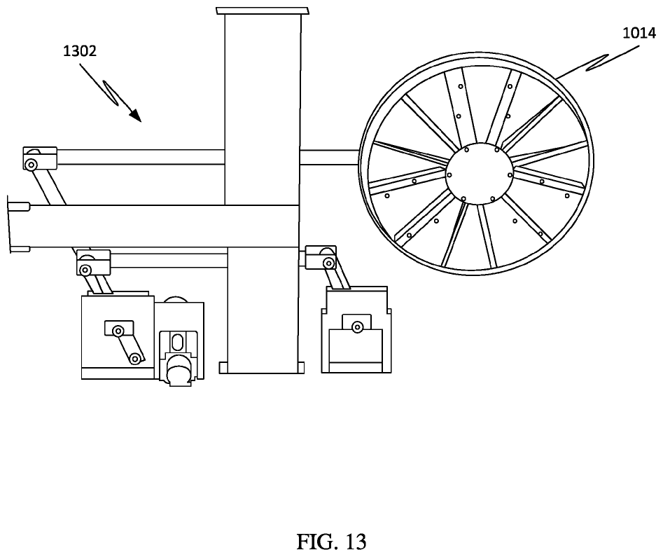

FIG. 13 is a bottom view of the gear assembly 1302 of the energy generating system 100 with the permanent magnet generator 1014, in accordance with some embodiments.

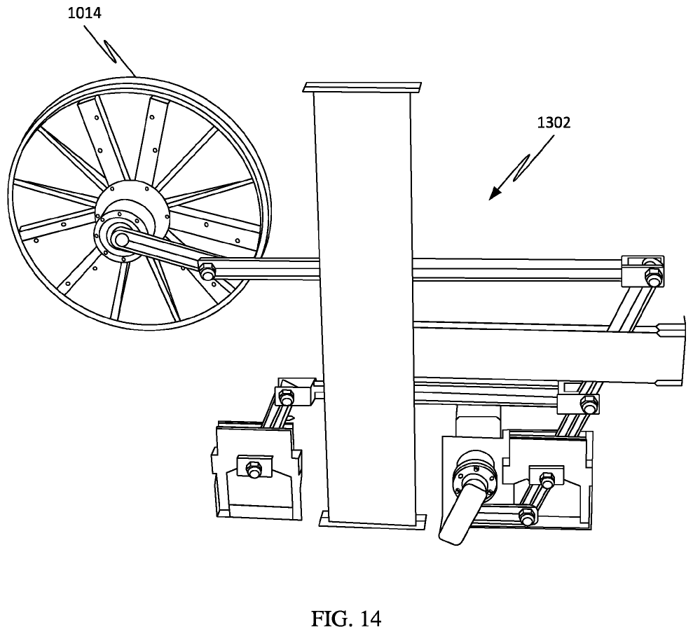

FIG. 14 is a top view of the gear assembly 1302 of the energy generating system 100 with the permanent magnet generator 1014, in accordance with some embodiments.

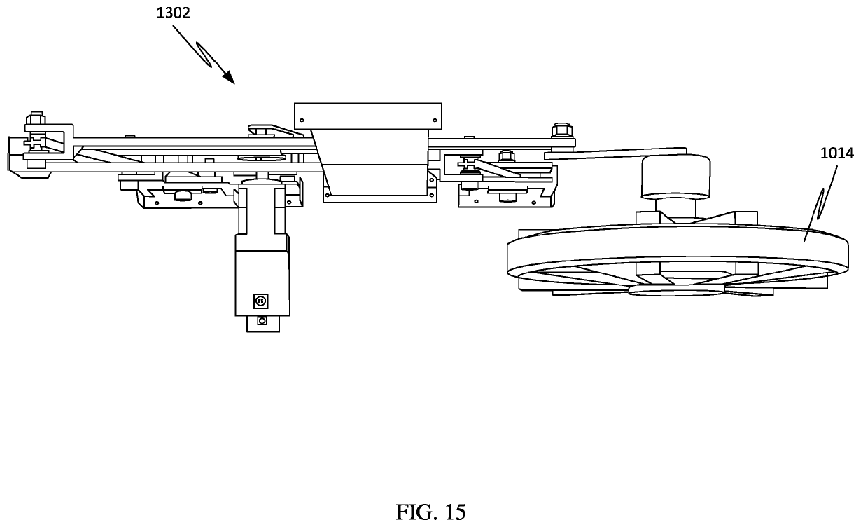

FIG. 15 is a rear view of the gear assembly 1302 of the energy generating system 100 with the permanent magnet generator 1014, in accordance with some embodiments.

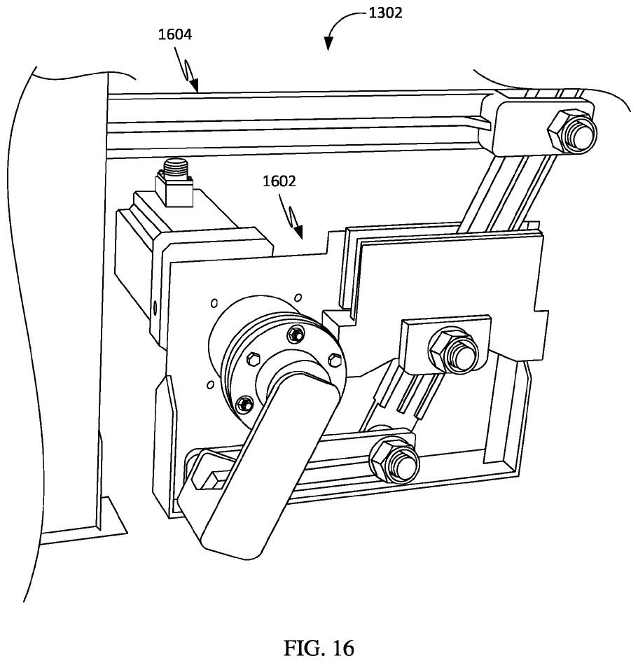

FIG. 16 is a top view of a gear box 1602 with a gear linkage 1604 of the gear assembly 1302, in accordance with some embodiments. Further, the gear box 1602 may be associated with a clutch transmission. Further, the gear linkage 1604 may include aluminum linkages with ceramic sleeve bushings and an aluminum linkage guide rail system.

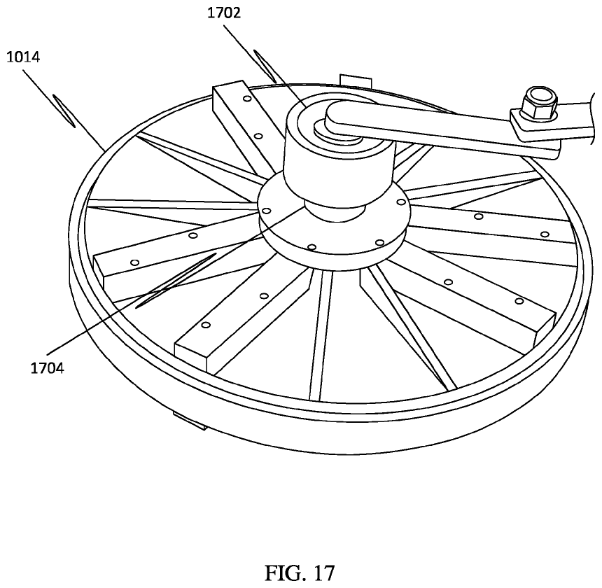

FIG. 17 is a bottom view of a transmission 1702 of the gear assembly 1302 with the permanent magnet generator 1014, in accordance with some embodiments. Further, the transmission 1702 may be a one-way freewheel indexing clutch. Further, the transmission 1702 may be associated with an encoder 1704. Further, the encoder 1704 may be a sensing device for providing a feedback associated with the permanent magnet generator 1014.

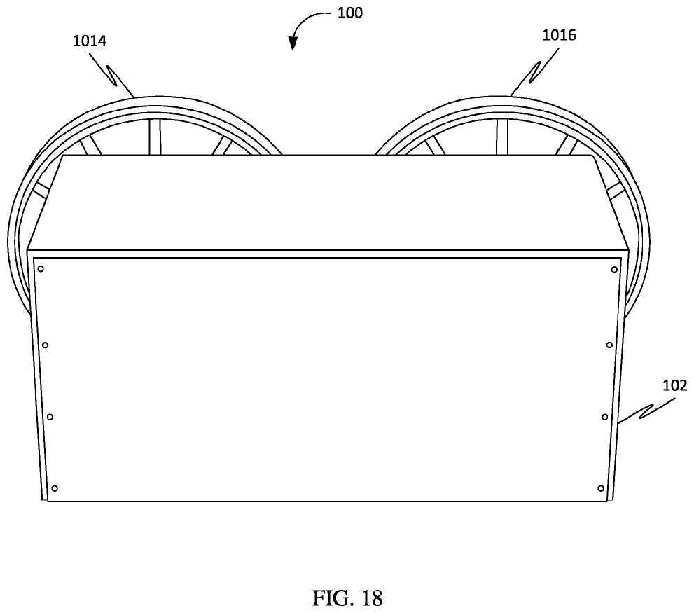

FIG. 18 is a rear perspective view of the energy generating system 100 with the at least one permanent magnet generator (1014 and 1016), in accordance with some embodiments.

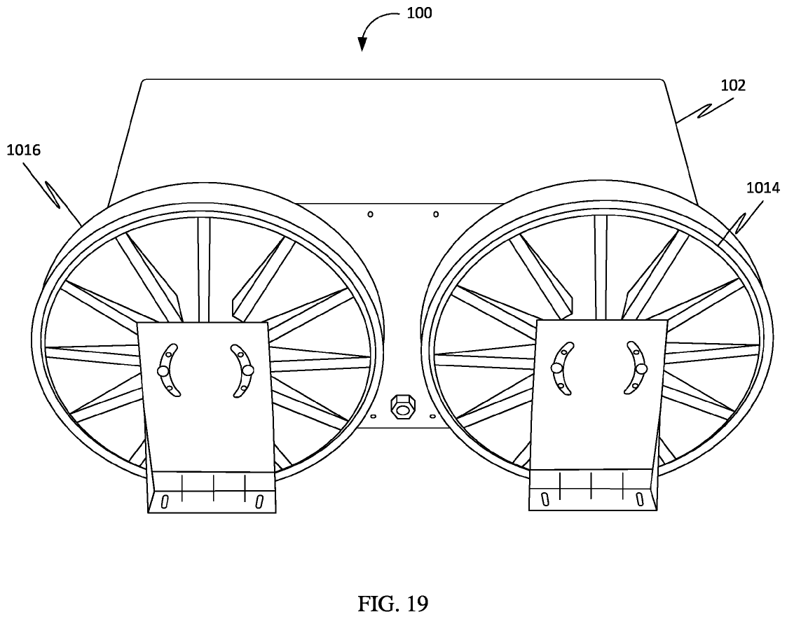

FIG. 19 is a front perspective view of the energy generating system 100 with the at least one permanent magnet generator (1014 and 1016), in accordance with some embodiments.

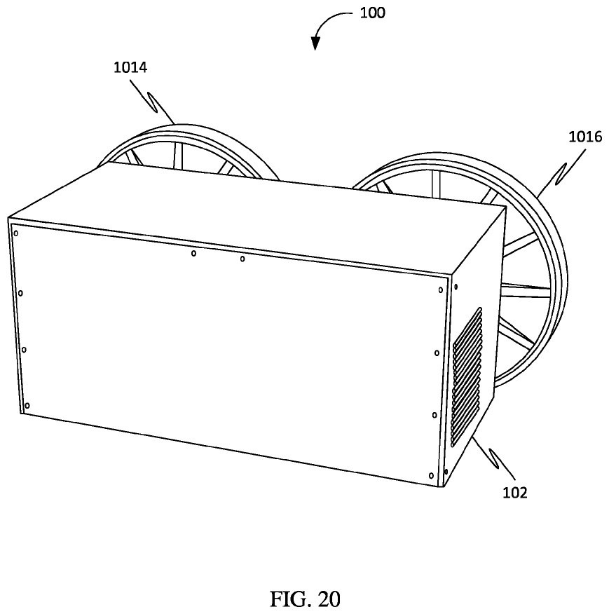

FIG. 20 is a left side perspective view of the energy generating system 100 with the at least one permanent magnet generator (1014 and 1016), in accordance with some embodiments.

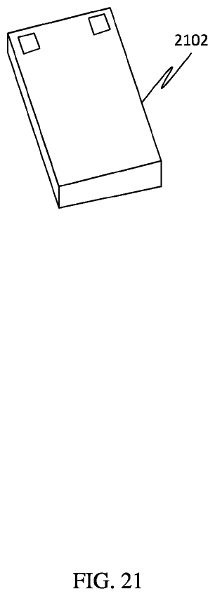

FIG. 21 is a top perspective view of a battery 2102 of the energy generating system 100, in accordance with some embodiments.

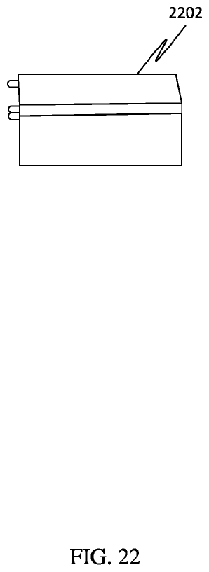

FIG. 22 is a top perspective view of an inverter 2204 of the energy generating system 100, in accordance with some embodiments. Further, the inverter 2204 may include a pure sine wave inverter for converting DC voltage to AC voltage.

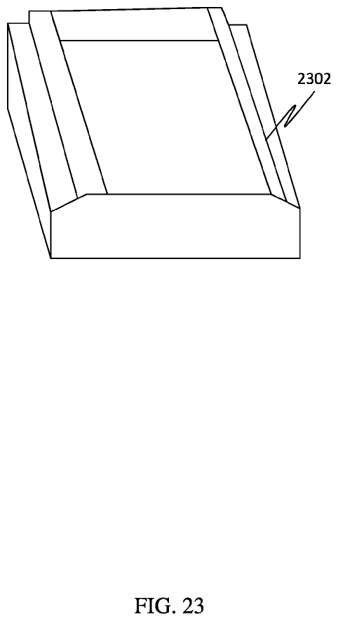

FIG. 23 is a top perspective view of a controller 2302 of the energy generating system 100, in accordance with some embodiments. Further, the controller 2302 may include a programmable logic controller (PLC).

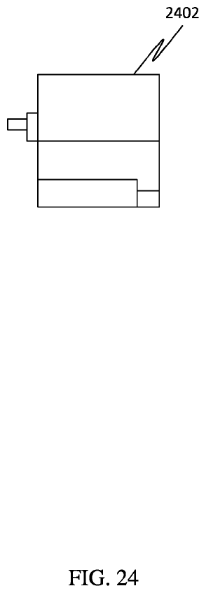

FIG. 24 is a top perspective view of a digital automatic voltage regulator (AVR) 2402 of the energy generating system 100, in accordance with some embodiments.

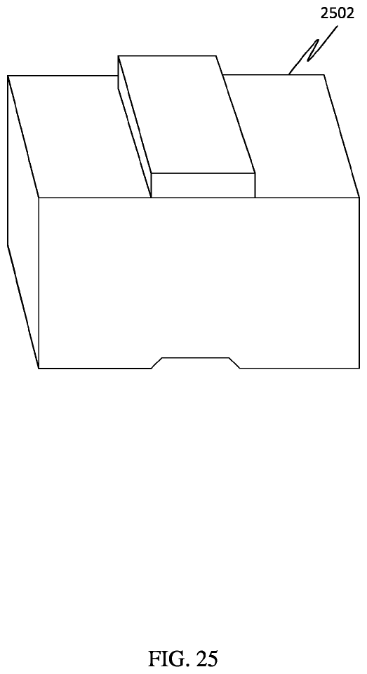

FIG. 25 is a top perspective view of a circuit breaker 2502 of the energy generating system 100, in accordance with some embodiments. Further, the circuit breaker 2502 may be associated with an output of the energy generating system 100.

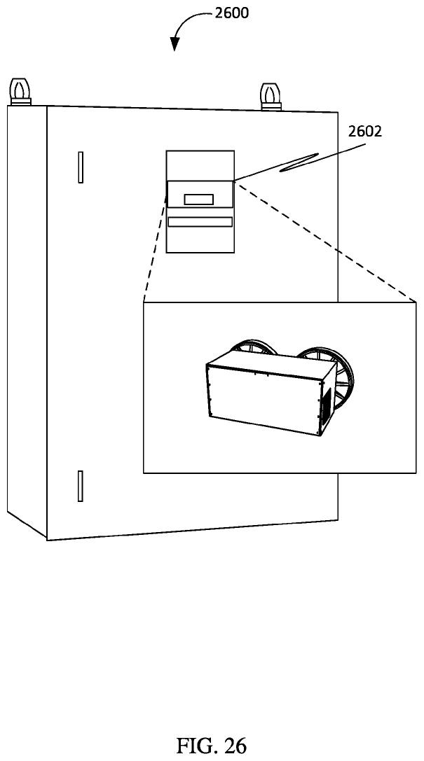

FIG. 26 is a front perspective view of a human machine interface device 2600 associated with the energy generating system 100, in accordance with some embodiments. Further, the human machine interface device 2600 may include an interface 2602.

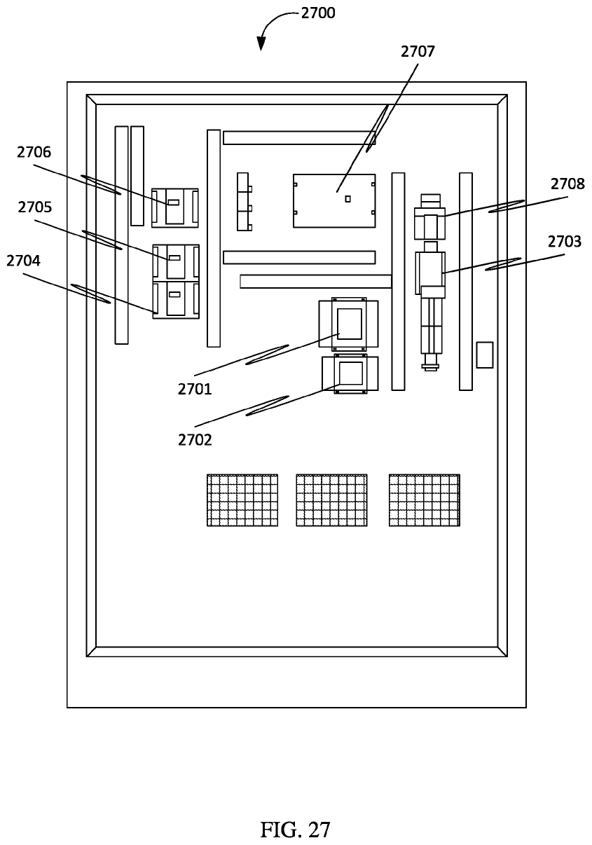

FIG. 27 is a front view of an energy management system 2700 for the energy generating system 100, in accordance with some embodiments. Further, the energy management system 2700 may include a battery 2701, a charger 2702 for the battery 2701, a programmable logic controller (PLC)/controller 2703, circuit breakers 2704 for backup power, circuit breakers 2705 from a permanent magnet generator (PMG), circuit breakers 2706 to devices (home devices, building devices, end user devices, etc.), automatic transfer switches 2707, and a power meter 2708.

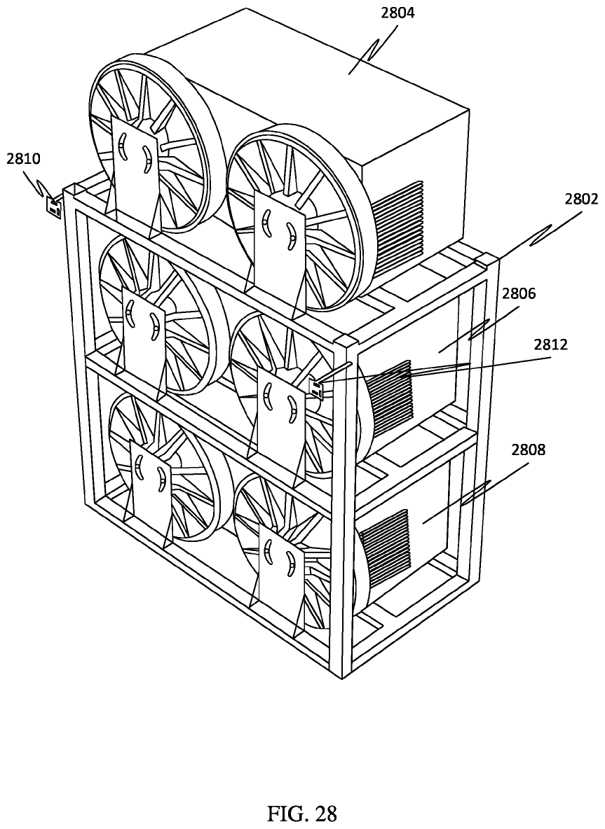

FIG. 28 is a perspective view of a stand 2802 for stacking a plurality of energy generating systems 2804-2808, in accordance with some embodiments. Further, the stand 2802 may include a plurality of securing elements 2810-2812 attached to the stand 2802 for securing the stand 2802 to at least one object for proving secure tying and seismic strapping for the stand 2802 comprising the plurality of energy generating systems 2804-2808.

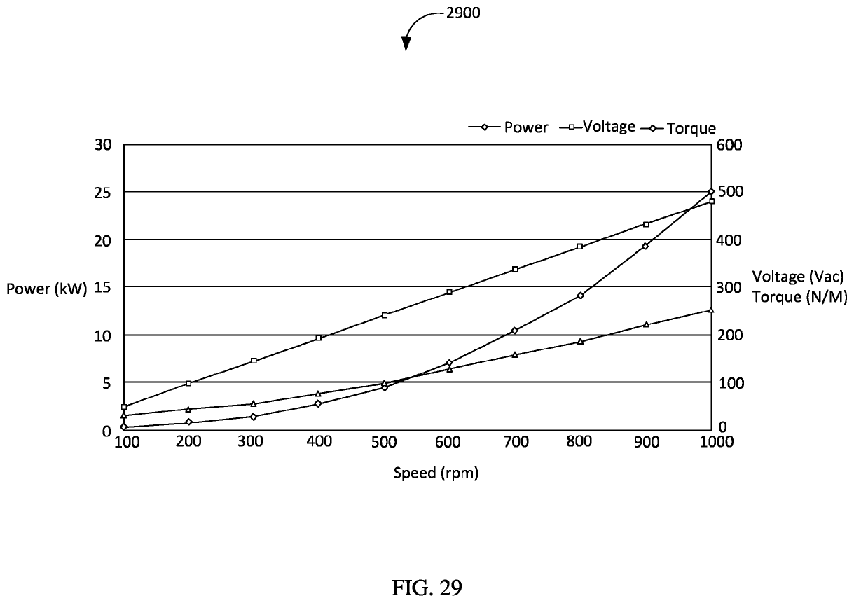

FIG. 29 is a graph 2900 illustrating a plurality of outputs produced by an energy generating system against a speed of the energy generating system, in accordance with some embodiments. Further, the plurality of outputs may include power (kW), voltage (Vac), torque (N/M), etc.

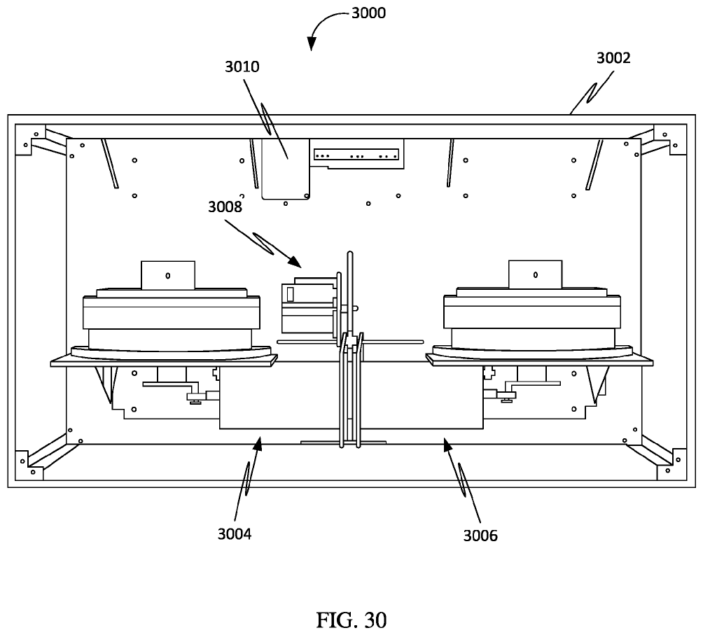

FIG. 30 is a top view of an energy generating system 3000 for facilitating generating energy on demand, in accordance with some embodiments. Accordingly, the energy generating system 3000 may include a housing 3002, two piston assemblies 3004-3006, a control assembly 3008, and at least one power source 3010.

Further, the two piston assemblies 3004-3006 may be disposed in the housing 3002. Further, the two piston assemblies 3004-3006 may include a first piston assembly 3004 and a second piston assembly 3006. Further, the first piston assembly 3004 opposes the second piston assembly 3006. Further, the first piston assembly 3004 may be spaced apart from the second piston assembly 3006 defining a space between the first piston assembly 3004 and the second piston assembly 3006. Further, each of the two piston assemblies 3004-3006 may include a cylinder, a piston movably disposed in the cylinder, and a connecting rod coupled with the piston. Further, the cylinder may include a spring coupled with the piston. Further, a first end of the spring may be attached to a first end portion of the cylinder and a second end of the spring may be attached to a rear surface of the piston. Further, the piston may include a magnet. Further, the magnet of the piston of the first piston assembly 3004 magnetically interacts with the magnet of the piston of the second piston assembly 3006 imparting a magnetic repulsion force on the piston of the first piston assembly 3004 and the piston of the second piston assembly 3006 for moving the piston within the cylinder in a first direction. Further, the spring transitions from an extended state to a compressed state based on the moving of the piston within the cylinder in the first direction. Further, the spring may be configured for transitioning from the compressed state to the extended state for moving the piston within the cylinder in a second direction opposite to the first direction. Further, the magnetically repelling of the piston and the transitioning of the spring from the compressed state to the extended state establishes a reciprocating movement of the piston in the cylinder. Further, the connecting rod may be coupled with a shaft disposed in the housing 3002. Further, the reciprocating movement of the piston rotates the shaft with at least one speed and at least one torque. Further, the shaft outputs a rotational energy based on the at least one speed and the at least one torque.

Further, the control assembly 3008 may be disposed in the housing 3002. Further, the control assembly 3008 may include at least one magnet shielding element and an actuator operatively coupled with the at least one magnet shielding element. Further, the actuator may be electrically powered. Further, the actuator may be configured for transitioning the at least one magnet shielding element between a first position and at least one second position in relation to the space. Further, the transitioning of the at least one magnet shielding element modifies a magnetic interaction between the magnet of the piston of the first piston assembly 3004 and the magnet of the piston of the second piston assembly 3006 varying the magnetic repulsion force between a first amount and at least one second amount. Further, the moving of the piston within the cylinder in the first direction may be based on the first amount of the magnetic repulsion force. Further, the transitioning of the spring from the compressed state to the extended state for the moving of the piston within the cylinder in the second direction may be based on the at least one second amount of the magnetic repulsion force.

Further, the at least one power source 3010 may be disposed in the housing 3002. Further, the at least one power source 3010 may be electrically coupled with the actuator of the control assembly 3008. Further, the at least one power source 3010 may be configured for electrically powering the actuator.

Further, in some embodiments, the at least one magnet shielding element allows the magnetic interaction in the first position for varying the magnetic repulsion force to the first amount. Further, the at least one magnet shielding element interrupts the magnetic interaction of at least one amount in the at least one second position for varying the magnetic repulsion force to the at least one second amount.

Further, in some embodiments, the transitioning of the at least one magnet shielding element between the first position and the at least one second position in relation to the space may include transitioning the at least one magnet shielding element between the first position and the at least one second position in relation to the space with at least one transitioning characteristic. Further, the at least one characteristic corresponds to at least one reciprocating movement characteristic of the reciprocating movement of the piston. Further, the at least one speed and the at least one torque associated with the shaft corresponds to the at least one reciprocating movement characteristic.

Further, in some embodiments, the piston may include a piston receptacle may include a piston interior space, and a piston opening leading into the piston interior space. Further, the magnet may be disposed in the piston interior space. Further, a first pole of a first polarity of the magnet faces a first end side of the piston receptacle and a second pole of a second polarity of the magnet faces a second end side of the piston receptacle. Further, the first end side opposes the second end side. Further, the piston opening may be comprised on the first end side.

In further embodiments, the energy generating system 3000 may include at least one electromagnetic clutch coupled with at least one of the two piston assemblies 3004-3006. Further, the at least one electromagnetic clutch may be electrically powered. Further, the at least one electromagnetic clutch may include an input member and an output member. Further, the input member may be mechanically coupled with the shaft for receiving the rotational energy from the shaft. Further, the at least one electromagnetic clutch may be configured for transmitting the rotational energy received at the input member to the output member based on at least one operation of the at least one electromagnetic clutch.

In an embodiment, the energy generating system 3000 may include at least one permanent magnet generator disposed on the housing 3002. Further, the at least one permanent magnet generator may be coupled with the at least one electromagnetic clutch. Further, a rotor shaft of the at least one permanent magnet generator may be mechanically coupled with the output member of the at least one electromagnetic clutch. Further, the at least one permanent magnet generator converts the rotational energy received at the rotor shaft to an electrical energy.

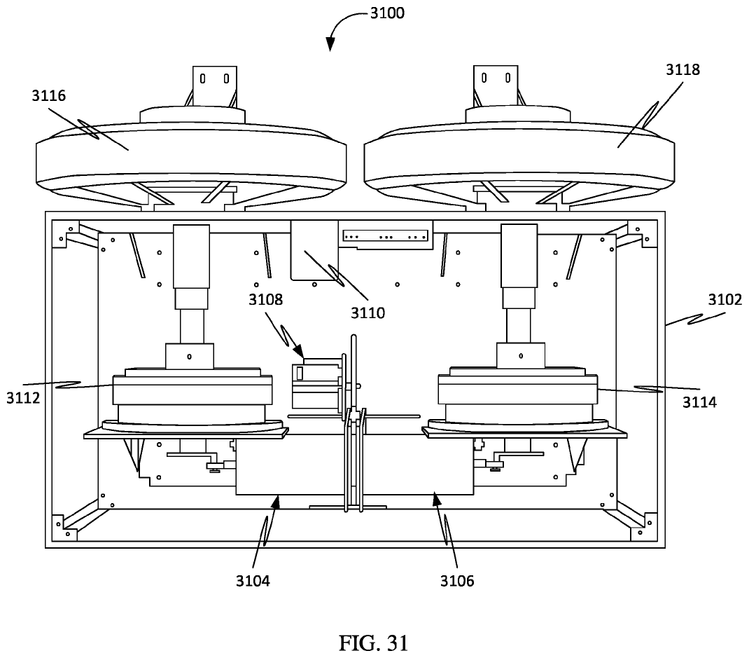

FIG. 31 is a top view of an energy generating system 3100 for facilitating generating energy on demand, in accordance with some embodiments. Accordingly, the energy generating system 3100 may include a housing 3102, two piston assemblies 3104-3106, a control assembly 3108, at least one power source 3110, at least one electromagnetic clutch (3112 and 3114), and at least one permanent magnet generator (3116 and 3118).

Further, the two piston assemblies 3104-3106 may be disposed in the housing 3102. Further, the two piston assemblies 3104-3106 may include a first piston assembly 3104 and a second piston assembly 3106. Further, the first piston assembly 3104 opposes the second piston assembly 3106. Further, the first piston assembly 3104 may be spaced apart from the second piston assembly 3106 defining a space between the first piston assembly 3104 and the second piston assembly 3106. Further, each of the two piston assemblies 3104-3106 may include a cylinder, a piston movably disposed in the cylinder, and a connecting rod coupled with the piston. Further, the cylinder may include a spring coupled with the piston. Further, a first end of the spring may be attached to a first end portion of the cylinder and a second end of the spring may be attached to a rear surface of the piston. Further, the piston may include a magnet. Further, the magnet of the piston of the first piston assembly 3104 magnetically interacts with the magnet of the piston of the second piston assembly 3106 imparting a magnetic repulsion force on the piston of the first piston assembly 3104 and the piston of the second piston assembly 3106 for moving the piston within the cylinder in a first direction. Further, the spring transitions from an extended state to a compressed state based on the moving of the piston within the cylinder in the first direction. Further, the spring may be configured for transitioning from the compressed state to the extended state for moving the piston within the cylinder in a second direction opposite to the first direction. Further, the magnetically repelling of the piston and the transitioning of the spring from the compressed state to the extended state establishes a reciprocating movement of the piston in the cylinder.

Further, the connecting rod may be coupled with a shaft disposed in the housing 3102. Further, the reciprocating movement of the piston rotates the shaft with at least one speed and at least one torque. Further, the shaft outputs a rotational energy based on the at least one speed and the at least one torque.

Further, the control assembly 3108 may be disposed in the housing 3102. Further, the control assembly 3108 may include at least one magnet shielding element and an actuator operatively coupled with the at least one magnet shielding element. Further, the actuator may be electrically powered. Further, the actuator may be configured for transitioning the at least one magnet shielding element between a first position and at least one second position in relation to the space. Further, the transitioning of the at least one magnet shielding element modifies a magnetic interaction between the magnet of the piston of the first piston assembly 3104 and the magnet of the piston of the second piston assembly 3106 varying the magnetic repulsion force between a first amount and at least one second amount. Further, the moving of the piston within the cylinder in the first direction may be based on the first amount of the magnetic repulsion force. Further, the transitioning of the spring from the compressed state to the extended state for the moving of the piston within the cylinder in the second direction may be based on the at least one second amount of the magnetic repulsion force.

Further, the at least one power source 3110 may be disposed in the housing 3102. Further, the at least one power source 3110 may be electrically coupled with the actuator of the control assembly 3108. Further, the at least one power source 3110 may be configured for electrically powering the actuator.

Further, the at least one electromagnetic clutch (3112 and 3114) may be coupled with at least one of the two piston assemblies 3104-3106. Further, the at least one electromagnetic clutch (3112 and 3114) may be electrically powered. Further, the at least one electromagnetic clutch (3112 and 3114) may include an input member and an output member. Further, the input member may be mechanically coupled with the shaft for receiving the rotational energy from the shaft. Further, the at least one electromagnetic clutch (3112 and 3114) may be configured for transmitting the rotational energy received at the input member to the output member based on at least one operation of the at least one electromagnetic clutch (3112 and 3114).

Further, the at least one permanent magnet generator (3116 and 3118) may be disposed on the housing 3102. Further, the at least one permanent magnet generator (3116 and 3118) may be coupled with the at least one electromagnetic clutch (3112 and 3114). Further, a rotor shaft of the at least one permanent magnet generator (3116 and 3118) may be mechanically coupled with the output member of the at least one electromagnetic clutch (3112 and 3114). Further, the at least one permanent magnet generator (3116 and 3118) converts the rotational energy received at the rotor shaft to an electrical energy.

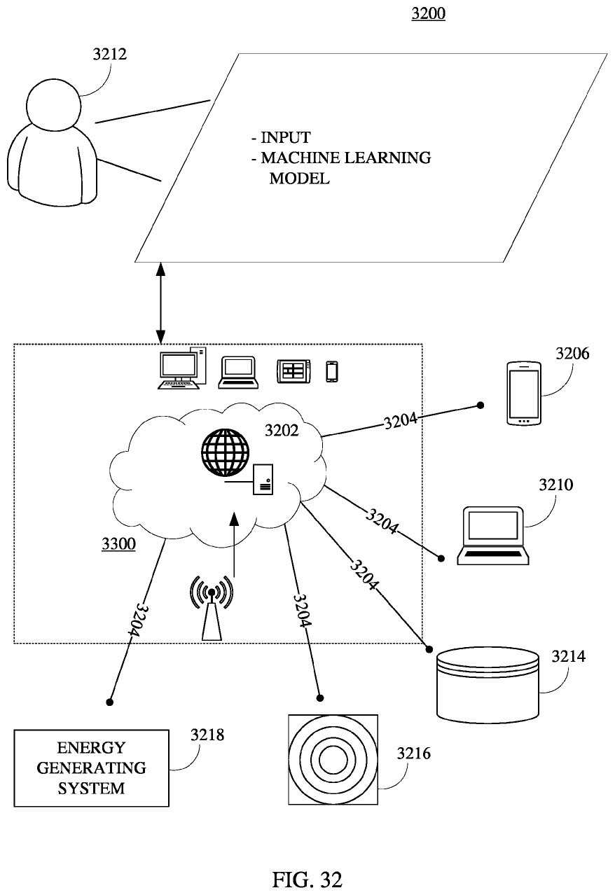

FIG. 32 is an illustration of an online platform 3200 consistent with various embodiments of the present disclosure. By way of non-limiting example, the online platform 3200 to facilitate generating of energy on demand using an energy generating system 3218 (such as the energy generating system 100, the energy generating system 3000, the energy generating system 3100, etc.) may be hosted on a centralized server 3202, such as, for example, a cloud computing service. The centralized server 3202 may communicate with other network entities, such as, for example, a mobile device 3206 (such as a smartphone, a laptop, a tablet computer, etc.), other electronic devices 3210 (such as desktop computers, server computers, etc.), databases 3214, sensors 3216, and an energy generating system 3218 over a communication network 3204, such as, but not limited to, the Internet. Further, users of the online platform 3200 may include relevant parties such as, but not limited to, end-users, administrators, service providers, service consumers and so on. Accordingly, in some instances, electronic devices operated by the one or more relevant parties may be in communication with the platform.

A user 3212, such as the one or more relevant parties, may access online platform 3200 through a web-based software application or browser. The web-based software application may be embodied as, for example, but not be limited to, a website, a web application, a desktop application, and a mobile application compatible with a computing device 3300.

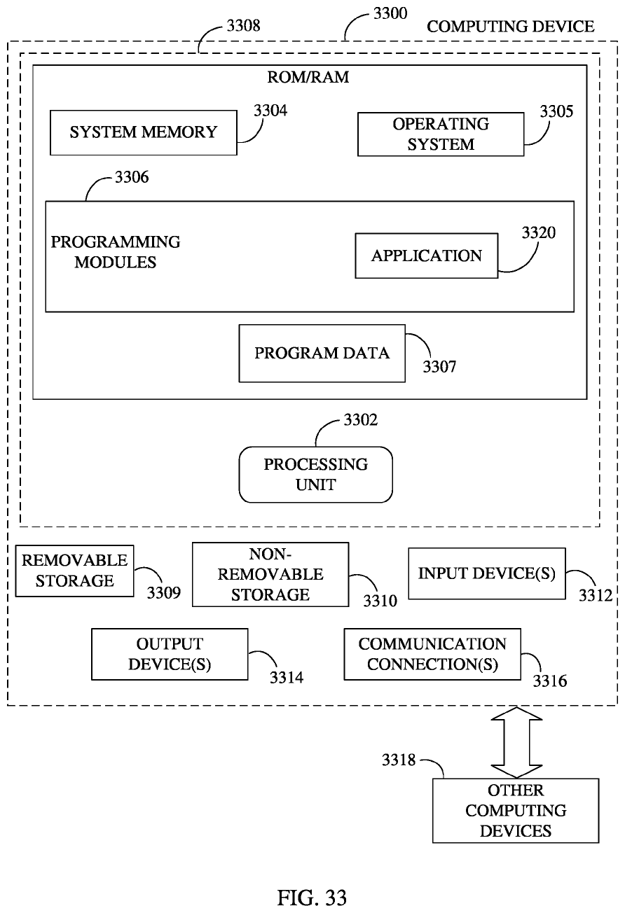

With reference to FIG. 33, a system consistent with an embodiment of the disclosure may include a computing device or cloud service, such as computing device 3300. In a basic configuration, computing device 3300 may include at least one processing unit 3302 and a system memory 3304. Depending on the configuration and type of computing device, system memory 3304 may comprise, but is not limited to, volatile (e.g., random-access memory (RAM)), non-volatile (e.g., read-only memory (ROM)), flash memory, or any combination. System memory 3304 may include operating system 3305, one or more programming modules 3306, and may include a program data 3307. Operating system 3305, for example, may be suitable for controlling computing device 3300's operation. In one embodiment, programming modules 3306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 33 by those components within a dashed line 3308.

Computing device 3300 may have additional features or functionality. For example, computing device 3300 may also include additional data storage devices (removable and/or non-removable) such as, for example, magnetic disks, optical disks, or tape. Such additional storage is illustrated in FIG. 33 by a removable storage 3309 and a non-removable storage 3310. Computer storage media may include volatile and non-volatile, removable and non-removable media implemented in any method or technology for storage of information, such as computer-readable instructions, data structures, program modules, or other data. System memory 3304, removable storage 3309, and non-removable storage 3310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3300. Any such computer storage media may be part of device 3300. Computing device 3300 may also have input device(s) 3312 such as a keyboard, a mouse, a pen, a sound input device, a touch input device, a location sensor, a camera, a biometric sensor, etc. Output device(s) 3314 such as a display, speakers, a printer, etc. may also be included. The aforementioned devices are examples and others may be used.

Computing device 3300 may also contain a communication connection 3316 that may allow device 3300 to communicate with other computing devices 3318, such as over a network in a distributed computing environment, for example, an intranet or the Internet. Communication connection 3316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3304, including operating system 3305. While executing on processing unit 3302, programming modules 3306 (e.g., application 3320 such as a media player) may perform processes including, for example, one or more stages of methods, algorithms, systems, applications, servers, databases as described above. The aforementioned process is an example, and processing unit 3302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

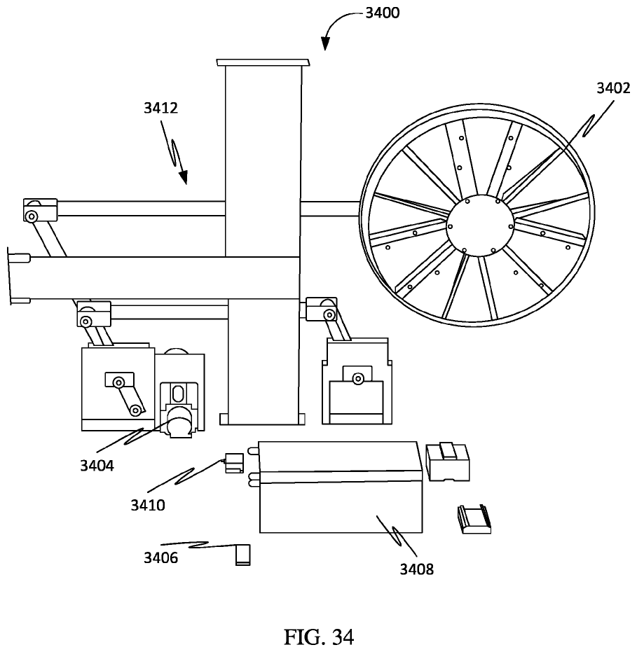

FIG. 34 is a disassembled front perspective view of an energy generating system 3400 for facilitating generating energy on demand, in accordance with some embodiments. Accordingly, the energy generating system 3400 may include at least one permanent magnet generator (PMG) 3402, at least one drive system 3404, at least one power source 3406-3408, and at least one automatic voltage regulator (AVR) 3410.

Further, the at least one drive system 3404 may be mechanically coupled with the at least one permanent magnet generator 3402 using a gear assembly 3412. Further, the at least one drive system 3404 may be configured for driving the at least one permanent magnet generator 3402. Further, the at least one permanent magnet generator 3402 may be configured for generating an electrical energy based on the driving. Further, the driving of the at least one permanent magnet generator 3402 may include driving the at least one permanent magnet generator 3402 during a starting phase and driving the at least one permanent magnet generator 3402 after the starting phase. Further, the at least one permanent magnet generator 3402 approaches an operating speed based on the driving of the at least one permanent magnet generator 3402 during the starting phase. Further, the at least one permanent magnet generator 3402 runs with the operating speed based on the driving of the at least one permanent magnet generator 3402 after the starting phase.

Further, the at least one power source 3406-3408 may be configured for powering the at least one drive system 3404 during the starting phase. Further, the driving of the at least one permanent magnet generator 3402 during the starting phase may be based on the powering of the at least one drive system 3404 during the starting phase. Further, in an embodiment, the least one power source 3406-3408 may include a battery 3406 and a pure sine wave inverter 3408.

Further, the at least one automatic voltage regulator 3410 may be electrically coupled with the at least one permanent magnet generator 3402. Further, the at least one automatic voltage regulator 3410 may be configured for powering the at least one drive system 3404 after the starting phase based on the electrical energy receivable by the at least one automatic voltage regulator 3410 from the at least one permanent magnet generator 3402. Further, the driving of the at least one permanent magnet generator 3402 after the starting phase may be based on the powering of the at least one drive system 3404 after the starting phase.

Further, in some embodiments, the at least one drive system 3404 may include at least one motor.

Further, in some embodiments, the at least one power source 3406-3408 may be configured to be transitionable between a powering mode and an idle mode. Further, the at least one power source 3406-3408 powers the at least one drive system 3404 during the starting phase in the powering mode. Further, the at least one power source 3406-3408 does not power the at least one drive system 3404 after the starting phase.

Further, in some embodiments, the at least one drive system 3404 may include two piston assemblies and a control assembly.

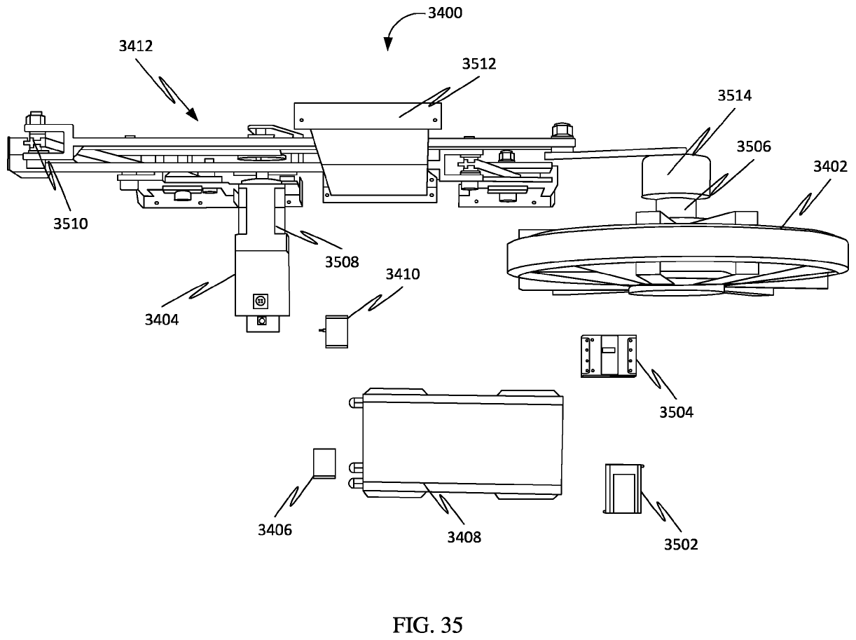

FIG. 35 is a disassembled top view of the energy generating system 3400, in accordance with some embodiments. Further, the energy generating system 3400 may include a controller (programmable logic controller (PLC)) 3502, circuit breakers 3504, and an encoder 3506. Further, the encoder 3506 may be a sensing device (such as a sensor) that provides a feedback associated with the at least one permanent magnet generator 3402. Further, the gear assembly 3412 may include a gearbox with a clutch transmission 3508, a linkage with a ceramic sleeve bushing 3510, a linkage guide rail system 3512, and a transmission (such as an one-way freewheel indexing clutch) 3514.

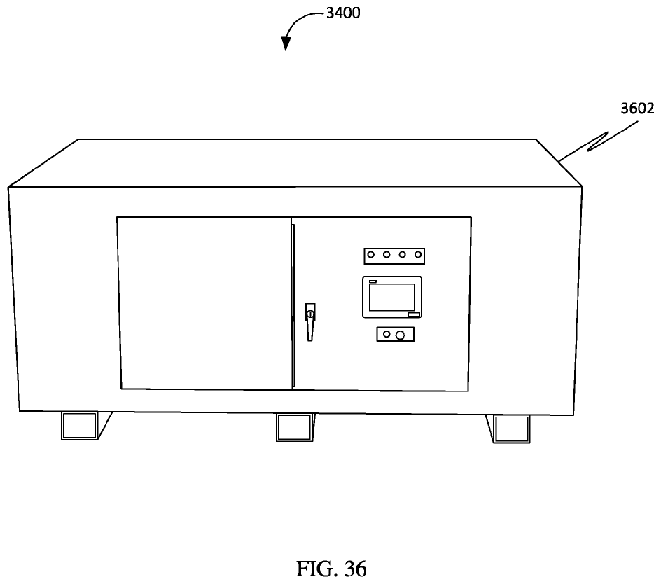

FIG. 36 is a front perspective view of the energy generating system 3400 with a housing 3602, in accordance with some embodiments. Further, the energy generating system 3400 may be a horizontal variant. Further, the at least one permanent magnet generator 3402, the at least one drive system 3404, the at least one power source 3406-3408, and the at least one automatic voltage regulator 3410 may be housed in the housing 3602.

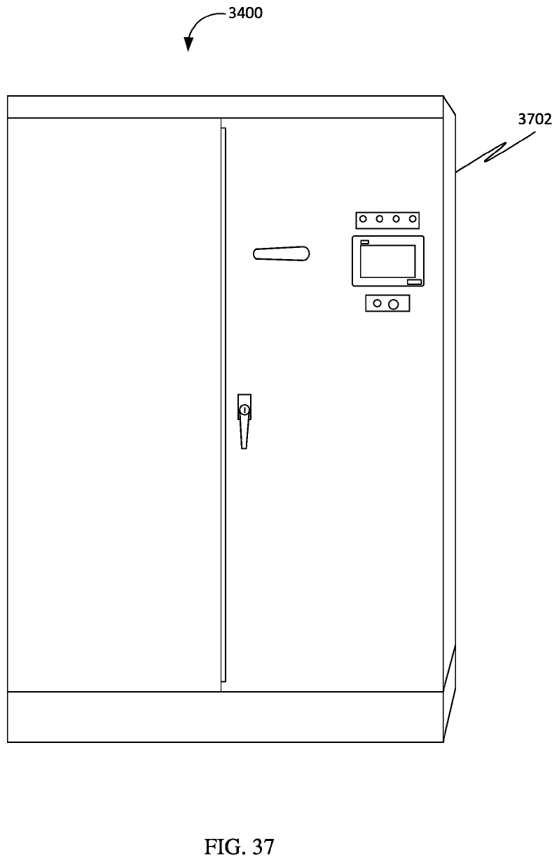

FIG. 37 is a front perspective view of the energy generating system 3400 with a housing 3702, in accordance with some embodiments. Further, the energy generating system 3400 may be a vertical variant. Further, the at least one permanent magnet generator 3402, the at least one drive system 3404, the at least one power source 3406-3408, and the at least one automatic voltage regulator 3410 may be housed in the housing 3702.

Although the present disclosure has been explained in relation to its preferred embodiment, it is to be understood that many other possible modifications and variations can be made without departing from the spirit and scope of the disclosure.

The invention claimed is:

1. An energy generating system for facilitating generating energy on demand, the energy generating system comprising:
at least one permanent magnet generator;
at least one drive system mechanically coupled with the at least one permanent magnet generator using a gear assembly, wherein the at least one drive system is configured for driving the at least one permanent magnet generator, wherein the at least one permanent magnet generator is configured for generating an electrical energy based on the driving, wherein the driving of the at least one permanent magnet generator comprises driving the at least one permanent magnet generator during a starting phase and driving the at least one permanent magnet generator after the starting phase, wherein the at least one permanent magnet generator approaches an operating speed based on the driving of the at least one permanent magnet generator during the starting phase, wherein the at least one permanent magnet generator runs with the operating speed based on the driving of the at least one permanent magnet generator after the starting phase;
at least one power source configured for powering the at least one drive system during the starting phase, wherein the driving of the at least one permanent magnet generator during the starting phase is further based on the powering of the at least one drive system during the starting phase;
at least one automatic voltage regulator electrically coupled with the at least one permanent magnet generator, wherein the at least one automatic voltage regulator is configured for powering the at least one drive system after the starting phase based on the electrical energy receivable by the at least one automatic voltage regulator from the at least one permanent magnet generator, wherein the driving of the at least one permanent magnet generator after the starting phase is based on the powering of the at least one drive system after the starting phase;
two piston assemblies disposed in a housing of the energy generating system, wherein the two piston assemblies comprise a first piston assembly and a second piston assembly, wherein the first piston assembly opposes the second piston assembly, wherein the first piston assembly is spaced apart from the second piston assembly defining a space between the first piston assembly and the second piston assembly, wherein each of the two piston assemblies comprises a cylinder, a piston movably disposed in the cylinder, and a connecting rod coupled with the piston, wherein the cylinder comprises a spring coupled with the piston, wherein a first end of the spring is attached to a first end portion of the cylinder and a second end of the spring is attached to a rear surface of the piston, wherein the piston comprises a magnet, wherein the magnet of the piston of the first piston assembly magnetically interacts with the magnet of the piston of the second piston assembly imparting a magnetic repulsion force on the piston of the first piston assembly and the piston of the second piston assembly for moving the piston within the cylinder in a first direction, wherein the spring transitions from an extended state to a compressed state based on the moving of the piston within the cylinder in the first direction, wherein the spring is configured for transitioning from the compressed state to the extended state for moving the piston within the cylinder in a second direction opposite to the first direction, wherein the magnetically repelling of the piston and the transitioning of the spring from the compressed state to the extended state establishes a reciprocating movement of the piston in the cylinder, wherein the connecting rod is coupled with a shaft disposed in the housing, wherein the reciprocating movement of the piston rotates the shaft with at least one speed and at least one torque, wherein the shaft outputs a rotational energy based on the at least one speed and the at least one torque; and
a control assembly disposed in the housing, wherein the control assembly comprises at least one magnet shielding element and an actuator operatively coupled with the at least one magnet shielding element, wherein the actuator is electrically powered, wherein the actuator is configured for transitioning the at least one magnet shielding element between a first position and at least one second position in relation to the space, wherein the transitioning of the at least one magnet shielding element modifies a magnetic interaction between the magnet of the piston of the first piston assembly and the magnet of the piston of the second piston assembly varying the magnetic repulsion force between a first amount and at least one second amount, wherein the moving of the piston within the cylinder in the first direction is based on the first amount of the magnetic repulsion force, wherein the transitioning of the spring from the compressed state to the extended state for the moving of the piston within the cylinder in the second direction is based on the at least one second amount of the magnetic repulsion force.

2. (canceled)

3. The energy generating system of claim 1, wherein the at least one power source is configured to be transitionable between a powering mode and an idle mode, wherein the at least one power source powers the at least one drive system during the starting phase in the powering mode, wherein the at least one power source does not power the at least one drive system after the starting phase.

4. (canceled)

5. The energy generating system of claim 1, wherein the at least one magnet shielding element allows the magnetic interaction in the first position for varying the magnetic repulsion force to the first amount, wherein the at least one magnet shielding element interrupts the magnetic interaction of at least one amount in the at least one second position for varying the magnetic repulsion force to the at least one second amount.

6. The energy generating system of claim 1, wherein the transitioning of the at least one magnet shielding element between the first position and the at least one second position in relation to the space comprises transitioning the at least one magnet shielding element between the first position and the at least one second position in relation to the space with at least one transitioning characteristic, wherein the at least one characteristic corresponds to at least one reciprocating movement characteristic of the reciprocating movement of the piston, wherein the at least one speed and the at least one torque associated with the shaft corresponds to the at least one reciprocating movement characteristic.

7. The energy generating system of claim 6, wherein the control assembly further comprises a processor communicatively coupled with the actuator, wherein the processor is configured for:
determining the at least one transitioning characteristic for the transitioning of the at least one magnet shielding element between the first position and the at least one second position in relation to the space; and
generating a command for the actuator based on the determining, wherein the transitioning of the at least one magnet shielding element between the first position and the at least one second position in relation to the space with the at least one transitioning characteristic is based on the command.

8. The energy generating system of claim 7, wherein the determining of the at least one transitioning characteristic for the transitioning of the at least one magnet shielding element between the first position and the at least one second position in relation to the space comprises determining the at least one transitioning characteristic for the transitioning of the at least one magnet shielding element between the first position and the at least one second position in relation to the space based on at least one machine learning model, wherein the at least one machine learning model predicts values for transitioning characteristics associated with the transitioning of the at least one magnet shielding element.

9. The energy generating system of claim 1, wherein the piston comprises a piston receptacle comprises a piston interior space, and a piston opening leading into the piston interior space, wherein the magnet is disposed in the piston interior space, wherein a first pole of a first polarity of the magnet faces a first end side of the piston receptacle and a second pole of a second polarity of the magnet faces a second end side of the piston receptacle, wherein the first end side opposes the second end side, wherein the piston opening is comprised on the first end side.

10. The energy generating system of claim 9, wherein the piston receptacle shields at least a portion of a magnetic field associated with the magnet for defining a field profile for the magnetic field associated with the magnet, wherein the magnetic interaction is based on an interaction of the magnetic field with the field profile of the magnet of the first piston assembly and the magnetic field with the field profile of the magnet of the second piston assembly.

11. The energy generating system of claim 1, wherein the at least one magnet shielding element is comprised of at least one material, wherein the at least one material comprises silicon iron alloy.

12. The energy generating system of claim 1 further comprising at least one electromagnetic clutch coupled with at least one of the two piston assemblies, wherein the at least one electromagnetic clutch is electrically powered, wherein the at least one electromagnetic clutch comprises an input member and an output member, wherein the input member is mechanically coupled with the shaft for receiving the rotational energy from the shaft, wherein the at least one electromagnetic clutch is configured for transmitting the rotational energy received at the input member to the output member based on at least one operation of the at least one electromagnetic clutch.

13. The energy generating system of claim 12, wherein the at least one permanent magnet generator is coupled with the at least one electromagnetic clutch, wherein a rotor shaft of the at least one permanent magnet generator is mechanically coupled with the output member of the at least one electromagnetic clutch, wherein the at least one permanent magnet generator converts the rotational energy received at the rotor shaft to the electrical energy.

14. (canceled)

15. (canceled)

16. (canceled)

17. (canceled)

18. (canceled)

19. (canceled)

20. (canceled)
